(19) United States
(12) Patent Application Publication
(10) Pub. No.: US 2010/0057621 A1
(43) Pub. Date: Mar. 4, 2010

(54) PAYMENT PROCESSING SYSTEM SECURE HEALTHCARE DATA TRAFFICKING

(76) Inventors: Patrick L. Faith, Pleasanton, CA (US); Stacy Pourfallah, Oakland, CA (US); Janet Pruitt, Madison, AL (US); Russell D. Weinstein, San Francisco, CA (US)

Correspondence Address: Quarles & Brady LLP, TWO NORTH CENTRAL AVENUE, One Renaissance Square, PHOENIX, AZ, 85004-2391, US

(21) Appl. No.: 12/493,981

(22) Filed: Jun. 29, 2009

Related U.S. Application Data
(60) Provisional application No. 61/077,158, filed on Jun. 30, 2008.
(60) Provisional application No. 61/077,149, filed on Jun. 30, 2008.

(51) Int. Cl. H04L 9/32; G06Q 30/00; G06Q 50/00

(52) U.S. Cl. 705/71

(57) ABSTRACT

Healthcare purchase data from a transaction upon a patient's account may be required to be transported and stored for safeguarding patient confidentiality if sufficient to identify the patient and the purchase. To avoid non-compliance, a transaction hander (TH) receives the data from a merchant's acquirer as encrypted by a key known to both the acquirer and TH. After decrypting the data with that key, the TH re-encrypts it with a key known only to the TH, and then stored. After receiving an issuer's request for the data, the TH decrypts the data using its own key, re-encrypts it using a key known only to the TH and the issuer, and then sends it to the issuer who will decrypt the data using that key. The unencrypted data may be used by the issuer to demonstrate the issuer's regulatory compliance to a governmental entity.

### CROSS-REFERENCE TO RELATED APPLICATIONS

The case claims priority to U.S. Provisional Application Ser. No. 61/077,158 by Weinstein et al., filed on Jun. 30, 2008, titled “Secure Data Repository,” and to U.S. Provisional Application Ser. No. 61/077,149 by Weinstein et al., filed on Jun. 30, 2008, titled “Hardware Security Modules For Healthcare Data,” each of which is incorporated herein by reference.

### FIELD

The present invention relates generally to healthcare transaction processing for businesses, and more particularly to secure data transfer of electronic protected health information in healthcare transaction processing.

### BACKGROUND

Many employers offer tax-advantaged employee benefits relative to healthcare reimbursement, transportation (transit and parking) and dependent care expenses. Employers may provide employees with payment for these purposes or permit payroll deductions, up to the limits defined by the United States Internal Revenue Service (IRS). In both cases, the employer is eligible for savings on Federal Insurance Contributions Act (FICA) taxes on these amounts. To be in compliance with IRS requirements, the employer must adopt a program to ensure that these dollars are spent only for the qualified category of goods or services for the particular benefit area. There are several types of such employee benefits accounts, including flexible spending accounts, healthcare reimbursement arrangements and health savings accounts. For convenience of reference, these types of accounts are referred to herein as “healthcare account.”

The IRS has issued rulings that apply to the use of healthcare accounts at merchants with “non-medical” Merchant Category Codes (MCC) who sell healthcare products. Non-medical MCC merchants include: Grocers/supermarkets, discount stores/warehouse clubs, convenience stores, web-based/mail-order/telephone-order pharmacies, and drug stores/pharmacies, for example. The rulings provide that in order for healthcare transactions to be made payable on such healthcare accounts, the non-medical merchants must verify that purchases made with the corresponding healthcare accounts are restricted to eligible healthcare products. In the United States, these non-medical merchants must be able to electronically identify the eligible healthcare products they sell through what the IRS calls an Inventory Information Approval System, or IIAS.

At times, the IRS may perform an audit of healthcare related sales of the merchant to confirm compliance with the ruling. For example, IRS Notice 2006-69 states that benefit plan administrators (e.g., employers) must be able to retrieve line item transaction detail on “Receipt Detail” for audit purposes, to verify compliance with IRS rules for healthcare account programs. Verification begins with audit requests initiated to employer benefit plans, which begins the process of requesting Receipt Detail via the payment network to confirm the purchases of only eligible medical/healthcare products. Merchants are responsible for storing (or arranging to have stored on their behalf) the Receipt Detail. Receipt Detail is comprised of both transaction and product level data for Healthcare Auto-Substantiation Transactions. Auto substantiation of a transaction is verifying, electronically, that benefit account funds were used for eligible expenses according to predetermined regulations, such as IRS regulations. IRS regulations, for instance, require that all benefits account transactions be substantiated—either electronically or manually. By way of example, regulations may permit automatic (electronic) substantiation of transactions that exactly matched group health plan co-payments, or for matches of multiple co-payments. Automatic substantiation, in another example, might be permitted when: 1) the group health plan has co-payments in a specific dollar amount, 2) the merchant or service provider has the proper MCC code, and 3) the dollar amount of the transaction equals an exact multiple of not more than five times the amount of the co-payment for a specific service or benefit. For example, under an employer sponsored health plan office visit co-payments are $5 per covered individual per visit. The employee takes herself and her two covered dependent children to the doctor's office. Together they incur 3 co-payments totaling $15. The employee uses her FSA debit card to pay the $15 charge. The charge is automatically substantiated since 1) the plan co-payment is $5, 2) the doctor's office has a proper MCC code of a medical service provider and 3) the total amount of the transaction is less than five times the co-payment amount. However, in the same scenario above, if employee had six children totaling six co-payments the amount would not automatically substantiate since the total is greater than five times the co-payment. Proper documentation would be requested in order to complete the transaction. The same rules apply for prescription purchases at a pharmacy. Provided 1) the plan has a designated co-payment for the benefit, 2) the pharmacy has the proper MCC code and 3) the total transaction amount does not exceed five co-payments, the transaction will auto-substantiate.

In order to have healthcare transaction data available for potential IRS audits, for the verification of proper automatic substantiation transactions, the healthcare related transactions data should be stored for duration of time, such as five years. Other uses for such healthcare transaction data include: employers providing reports to employees using their respective healthcare accounts.

Healthcare transactions with a corresponding merchant (e.g., non-medical merchants) may include both product data (e.g., medication purchased from a merchant) and consumer data (e.g., a consumer name or an account number associated with the consumer). The combination of the product data and the consumer data within the healthcare transaction can lead to the identification of a specific consumer in connection with healthcare that the specific consumer may be receiving. Some counties, such as the United States of America, regulate the electronic transmission and storage of such identifiable healthcare data “electronic Protected Health Information” (ePHI)). An example of such a regulation is the Health Insurance Portability and Accountability Act (HIPAA).

Given the forgoing, there is a need for a system that allows merchants selling healthcare products, employers offering healthcare account options to their employees, and corresponding issuers of healthcare accounts (collectively “participants”) to be able to store healthcare transactions in an automated manner that is compliant with regulatory standards.

### SUMMARY

The present application discloses the transfer of electronic Protected Health Information (ePHI) incident to a purchase transaction. The ePHI can be securely stored and subsequently accessed by participants via a payment processing system. The payment processing system infrastructure can be used to establish processing relationships between participants in the payment processing system. The processing relationships can be implemented such that an authentication table is not needed to define participants' access rights to the ePHI. As such, supplemental data, outside of the standard payment transaction data element universe, is securely stored for subsequent retrieval. Also, an individual healthcare-related product purchased in a transaction can be categorized for subsequent retrieval.

In one implementation, a patient's purchase from a merchant of a healthcare item is included in data from a transaction upon the patient's account. The data may be required to be transported and stored for safeguarding patient confidentiality if sufficient to identify the patient and the purchase. To avoid non-compliance, a transaction hander (TH) receives the data from a merchant's acquirer as encrypted by a key known to both the acquirer and TH. After decrypting the data with that key, the TH re-encrypts it with a key known only to the TH, and then stored by the TH in that encrypted form. After receiving an issuer's request for the data, the TH decrypts the data using its own key, re-encrypts it using a key known only to the TH and the issuer, and then sends it to the issuer. The issuer can then decrypt the data using the key known only to the TH and the issuer. The unencrypted data may be used by the issuer to demonstrate the issuer's regulatory compliance, such as may be required by a governmental entity, or for internal auditor purposes.

The foregoing advantages will appear in the detailed description that follows. In the description, reference is made to the accompanying drawings.

### BRIEF DESCRIPTION OF THE DRAWINGS

Implementations of the invention will become more apparent from the detailed description set forth below when taken in conjunction with the drawings.

FIG. 1 depicts a block diagram of an exemplary method having steps for implementing an Encryption Algorithm (EA) version for the transfer of electronic Protected Health Information (ePHI) in a transaction conducted with a healthcare provider (e.g., a merchant) in a payment processing network;

FIG. 2 depicts a block diagram of an exemplary method having steps for storing data implemented with an EA version for the transfer of ePHI in a transaction conducted with a healthcare provider (e.g., a merchant) in a payment processing network;

FIG. 3 depicts a block diagram of an exemplary method having steps for an issuer processor to retrieve data implemented with an EA version for the transfer of ePHI in a transaction conducted with a healthcare provider (e.g., a merchant) in a payment processing network;

FIG. 4 depicts a block diagram of an exemplary method having steps for an acquirer processor to retrieve data implemented with an EA version for the transfer of ePHI in a transaction conducted with a healthcare provider (e.g., a merchant) in a payment processing network;

FIGS. 5a-5b depict respective block diagrams of an exemplary method having steps for the retrieval of data implemented with a Hardware Security Module (HSM) version for the transfer of ePHI in a transaction conducted with a healthcare provider (e.g., a merchant) in a payment processing network;

FIG. 6 depicts a block diagram of an exemplary method having steps for storing data implemented with an HSM version for the transfer of ePHI in a transaction conducted with a healthcare provider (e.g., a merchant) in a payment processing network;

FIG. 7 depicts a block diagram of an exemplary method having steps for requesting data under a Data Repository (DR) implementation for the transfer of ePHI in a transaction conducted with a healthcare provider (e.g., a merchant) in a payment processing network;

FIG. 8 depicts a block diagram of an exemplary method having steps for the retrieval of data for an audit request under a non-integrated Data Repository (DR) implementation with respect to a transaction conducted with a healthcare provider (e.g., a merchant) in a payment processing network;

FIG. 9 depicts a block diagram of an exemplary method having steps for an issuer processor to retrieve data implemented with an HSM version for the transfer of ePHI in a transaction conducted with a healthcare provider (e.g., a merchant) in a payment processing network;

FIG. 10 depicts a block diagram of an exemplary method having steps for an acquirer processor to retrieve data implemented with an HSM version for the transfer of ePHI in a transaction conducted with a healthcare provider (e.g., a merchant) in a payment processing network;

FIG. 11 depicts a block diagram summarizing exemplary cryptographic flows in a Data Repository that is implemented with an HSM version for the transfer of ePHI in a transaction conducted with a healthcare provider (e.g., a merchant) in a payment processing network;

FIG. 12 depicts a diagram of data transfer between a plan and merchant through a web service;

FIG. 13 depicts a diagram of data flowing from a transaction conducted with a merchant in a payment processing network; and

FIG. 14 illustrates an exemplary payment processing network, depicting the general environment in which a transaction is conducted with a healthcare provider (e.g., a merchant).

### DETAILED DESCRIPTION

A consumer (e.g., a patient) is issued an account by an issuer. When the consumer engages in a transaction with a merchant (e.g., a healthcare provider) for a good or service (a product that is healthcare-related), the consumer provides information about the account to the merchant. The merchant sends the received account information and other transaction information (e.g., date of the transaction, amount of the transaction, Universal Product Code “UPC” or Stock Keeping Unit “SKU” of the healthcare-related product(s)) to an acquirer of the merchant. The acquirer, also know as the merchant's acquirer, then sends the transaction information to a transaction handler, such as Visa Inc., MasterCard, etc., who forwards the transaction information to the issuer of the account for approval (e.g., authorization of the transaction). If the transaction is authorized by the issuer, the merchant will be paid from the account via a clearing and settling process. Clearing includes the exchange of financial information between the issuer and the acquirer of the merchant, and settlement includes the transfer of funds.

In one implementation, which optionally may be performed by computing apparatus such as may be associated with a transaction handler, an authorization request is received from an address of an acquirer. The authorization request us for a transaction upon an account for a purchase of an item from a merchant. The authorization request includes an identifier for the account and a total currency amount for the purchase, but does not include information sufficient to identify both the account holder and the item of the purchase. The authorization request is sent to an address of an issuer in response to which there is received an authorization response containing an authorization of the transaction upon the account for the purchase of the item. The authorization response is sent for delivery to the address of the acquirer, after which information for the transaction is received from the address of the acquirer. The information for the transaction is not sufficient to identify both the account holder and the item of the purchase, but is sufficient for clearing and settling the transaction purchase. The information for the transaction is sent for delivery to the address of the issuer.

Acquirer encrypted data for the transaction is received from the address of the acquirer, preferably after or proximal to when the information for the transaction is sent for delivery to the address of the issuer. The acquirer encrypted data for the transaction will preferably have been formed by encrypting unencrypted data from the transaction using an acquirer zone key corresponding to the acquirer, and will preferably include information sufficient to identify both the account holder and the item of the purchase, but will preferably not include information sufficient to identify the acquirer zone key. The acquirer encrypted data for the transaction is decrypted using the acquirer zone key to form the unencrypted data from the transaction. The unencrypted data for the transaction is encrypted using a vault key to form vault encrypted data for the transaction which is stored. Optionally, the unencrypted data can be stored in a data repository vault with the vault encrypted data for the transaction.

After the vault encrypted data for the transaction is stored, there may be received, from an address of the issuer, a transaction detail request corresponding to the transaction. The transaction detail request is decrypted using the vault key to form the unencrypted data from the transaction which is then encrypted using an issuer zone key corresponding to the issuer to form issuer encrypted data for the transaction.

The issuer encrypted data for the transaction is sent out for delivery to the address of the issuer. The issuer encrypted data for the transaction includes information sufficient to identify both the account holder and the item of the purchase, but does not include information sufficient to identify the issuer zone key.

Optionally, the unencrypted data can be stored in a data repository vault with the vault encrypted data for the transaction.

It the account holder is a person and the item being purchase is related to healthcare, data collected at the merchant from the transaction can include electronic Health Protected Information (ePHI) or its equivalent is countries and jurisdictions outside the U.S.A.

In this implementation, the account was issued to an account holder by an issuer. The account holder is a participant in a transaction processing system in which a transaction handler processes each of a plurality of each transaction. Each transaction can be characterized by a merchant and an account holder engaging in the transaction upon an account that an issuer issued the account holder. The merchant submits the transaction to an acquirer for processing by the transaction handler who requests the issuer to obtain payment for the transaction from the account of the account holder. The issuer forwards the payment to the transaction handler who forwards the payment to the acquirer to pay the merchant for the transaction.

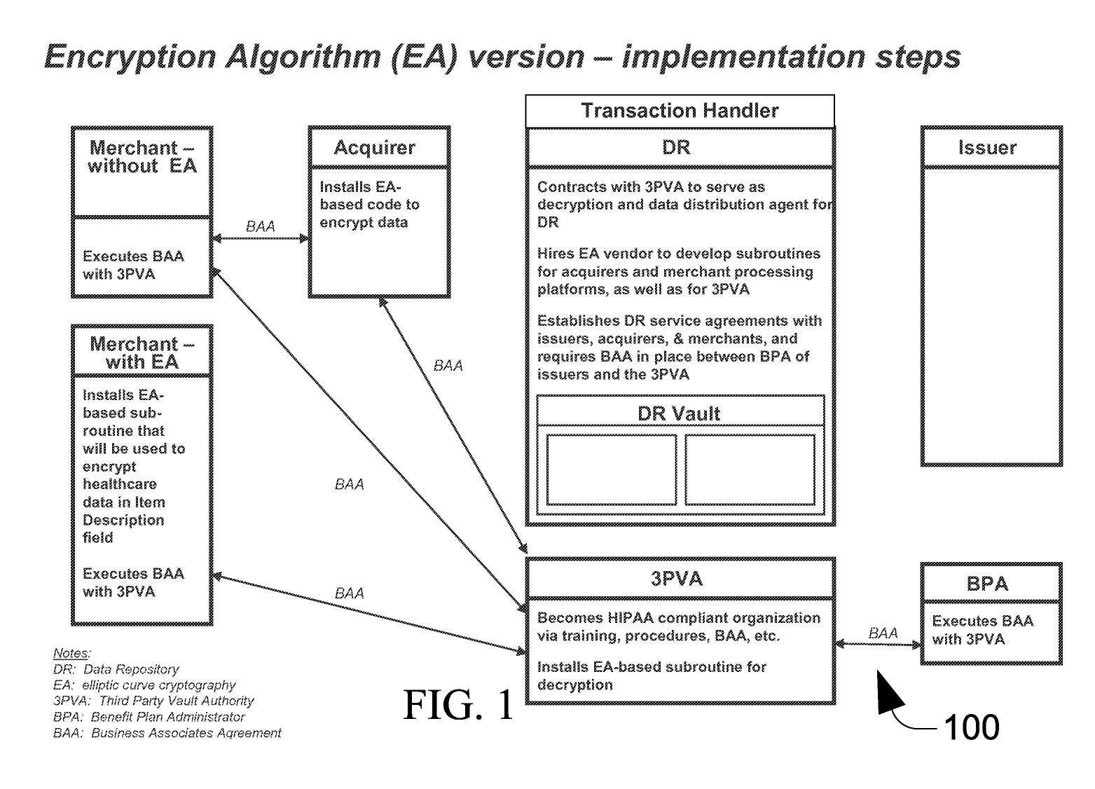

FIGS. 1-4 includes these abbreviations: VDR: Visa Data Repository; ECC: elliptic curve cryptography; 3PVA: Third Party Vault Authority; BPA: Benefit Plan Administrator; and BAA: Business Associates Agreement.

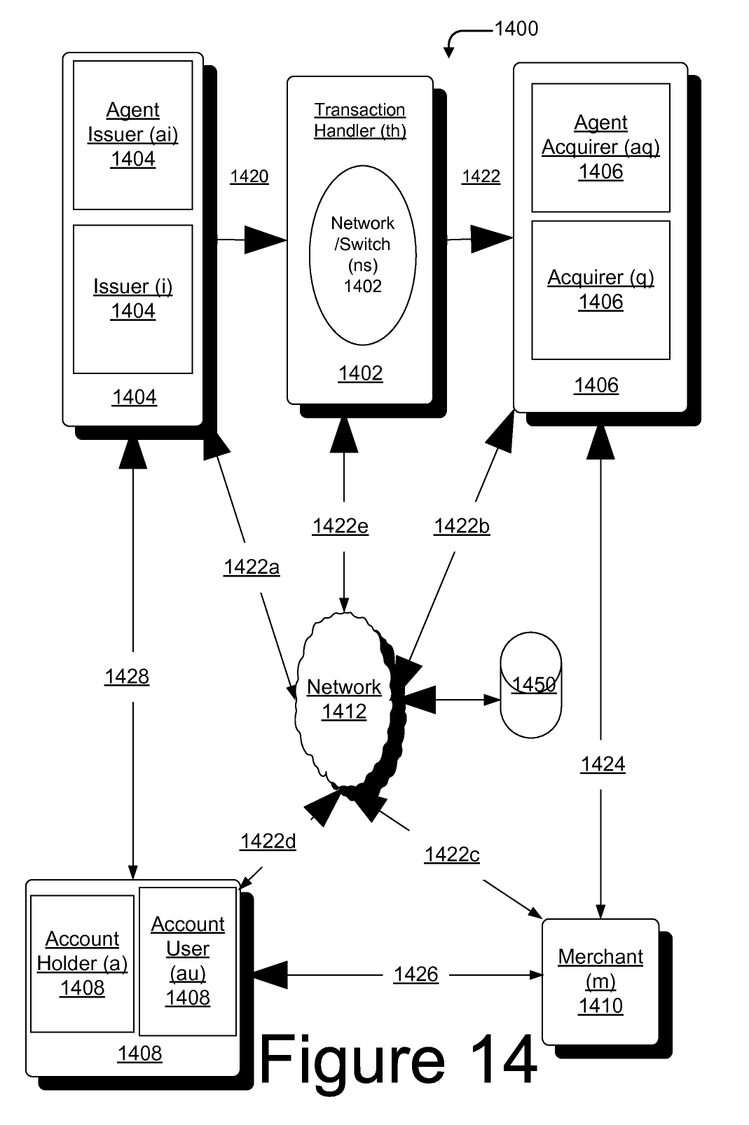

In one implementation, data related to a purchase transaction involved a healthcare-related good or service is securely stored and subsequently accessed by participants via a payment processing system, such as is described below with respect to FIG. 14. This type of data is considered to be “electronic Protected Health Information” (ePHI) (i.e., private information) if it includes enough information to identify the patent (e.g., account holder or cardholder) as well as purchases made by the cardholder's account (e.g., Flexible Savings Account (FSA), Health Savings Account (HSA) payment accounts, etc.)

The infrastructure of a payment processing system can be used to establish data processing relationships. One potential benefit of this approach can be to eliminate the need to build an authentication table to define participants' access rights to restricted data, such as ePHI. The implementation can be such that supplemental data, outside of the standard payment transaction data element universe, can be securely stored for subsequent retrieval by the participants. The implementation can also be such that individual healthcare-related products can be categorized for subsequent retrieval. In the payment processing system of this implementation, The transfer of ePHI for a healthcare-related transaction can be implemented using an encryption algorithm, such as elliptic curve cryptography (ECC), where ECC is used to encrypt at least portions of the ePHI. For example, a Data Repository (DR) for ePHI may rely on ECC to provide cryptographic protection of ePHI within the storage and retrieval processes for healthcare auto-substantiation transaction data. ECC is an approach to public key cryptography based on the algebraic structure of elliptical curves over finite fields.

To illustrate, participating acquirer processors (e.g., the acquirer) may be required to install, integrate, test and deploy a software program (referred to as a subroutine procedure) using ECC cryptographic standards to encrypt data in the Item Description field of the healthcare auto-substantiation transaction records. The ECC encryption of the Item Description field will prevent any identification of the healthcare-related purchase, thus preserving the patient's confidentiality.

Merchants who choose to participate in ECC encryption may have 2 service configuration options. The first option allows merchants to install an ECC-based subroutine procedure to encrypt data so they can participate directly in the service without routing data to their acquirer processor. The merchant under this implementation would send data directly to the transaction handler, such as Visa Inc., MasterCard, etc. Under the second option, a merchant could elect not to install the ECC-based subroutine procedures, and to send all data to their acquirer processor in an unencrypted fashion, who would then execute the ECC-based subroutine in their host environment to encrypt the data in the Item Description Fields.

The transaction handler will have a storage unit, referred to as the Data Repository (DR) Vault, where participating merchants' data would be stored. A Third Party Vault Authority (3PVA) would serve as a decryption and data distribution agent for the transaction handler and issuing side service participants. This allows the transaction handler to comply with Health Insurance Portability and Accountability Act (HIPAA), a federal regulation whose mission is to ensure the privacy and security of ePHI and other electronic medical records. Alternatively, or in combination, the 3PVA may manage the DR Vault and serve as the decryption and data distribution agent.

In one implementation, the storage process begins after a the transaction handler authorization has been approved and captured by the merchant. The merchant can create a data set from these transaction records which include its Product Line Item Detail (i.e., Item Description Field) for the purchase. This data is considered ePHI (i.e., private information) because it includes enough information to identify the cardholder as well as purchases made by the cardholder's Flexible Savings Account (FSA) or Health Savings Account (HSA) payment accounts, for example. The ePHI may be sent in batch form.

If the merchant has installed the ECC-based subroutine, then the merchant executes the subroutine to encrypt the data in the Item Description Fields. The resulting data set is then submitted to the transaction handler.

If the merchant does not have the ECC-based subroutine installed but the acquirer processor of the merchant (i.e., the merchant's acquirer) does have the ECC-based subroutine installed and is participating in the service, then the merchant can send the transaction records, including the Product Line Item Detail, to the corresponding acquirer processor. The corresponding acquirer processor will then execute its ECC-based subroutine to encrypt the data in the Item Description Fields. The resulting data set is then submitted to the transaction handler.

The transaction handler can receive all data, including the encrypted Item Descriptions from participating merchants and acquirer processors, and stores it in the DR Vault.

These handling procedures may be desirable for compliance with HIPAA requirements for ePHI, and to comport with security standards established and recommended by the National Institute of Standards & Technology (NIST) Key Management Guidelines.

In another implementation, the retrieval process may start when an issuer processor or acquirer processor, who participate in a Data Repository (DR), issues a retrieval request for data stored in the DR. An DR application for the DR may receive the request for specific healthcare transaction data and verify the requestor's access credentials and the data availability. The DR application will then send the requested transaction data, including the encrypted Item Description Data, from the DR Vault to the Third Party Vault Authority (3PVA). The 3PVA receives data from the DR, and then executes another ECC-based subroutine to decrypt the encrypted data in the Item Description Fields. The unencrypted data is then sent to a requesting DR Subscriber.

Turning now to FIG. 1, a block diagram 100, labeled “Encryption Algorithm (EA) version—implementation steps”, is presented as an environment for an exemplary implementation of steps that illustrate the use of an encryption algorithm (e.g., ECC) for storing healthcare transaction data in a DR Vault. This implementation illustrates two ways that a merchant can participate in an ECC configuration. In the first option, the merchant can participate in the DR service without deploying an ECC subroutine. Consequently, the merchant may participate in the ECC configuration implementation without downloading code to encrypt the transaction data within a local area network of the merchant. Rather, the merchant can off load encryption of the healthcare transaction data to its acquirer (the acquirer processor). In the second option, the merchant can participate by encoding the healthcare transaction data locally. Any such “direct” merchant can install the ECC base subroutine and use the subroutine to encrypt at least portions of the healthcare transaction data.

The direct merchant may directly participate in the DR process, such as by directly transmitting the at least partially encrypted healthcare transaction data to the transaction handler, or a third party vault authority represented by the 3PVA, in FIG. 1. The 3PVA may be an agent of the transaction handler or a separate entity. The various participants may wish to execute a Business Association Agreement (BAA) with the 3PVA. The transaction handler or the 3PVA may then store the healthcare transaction data into the DR Vault.

As more fully discussed below, the 3PVA may employ one or more Hardware Security Modules (HSM) to manage or protect encryption keys and the transmission of encrypted data to the appropriate encryption key holders. Therefore, in this implementation, the transaction handler may not need to manage corresponding encryption keys for corresponding zones between participants.

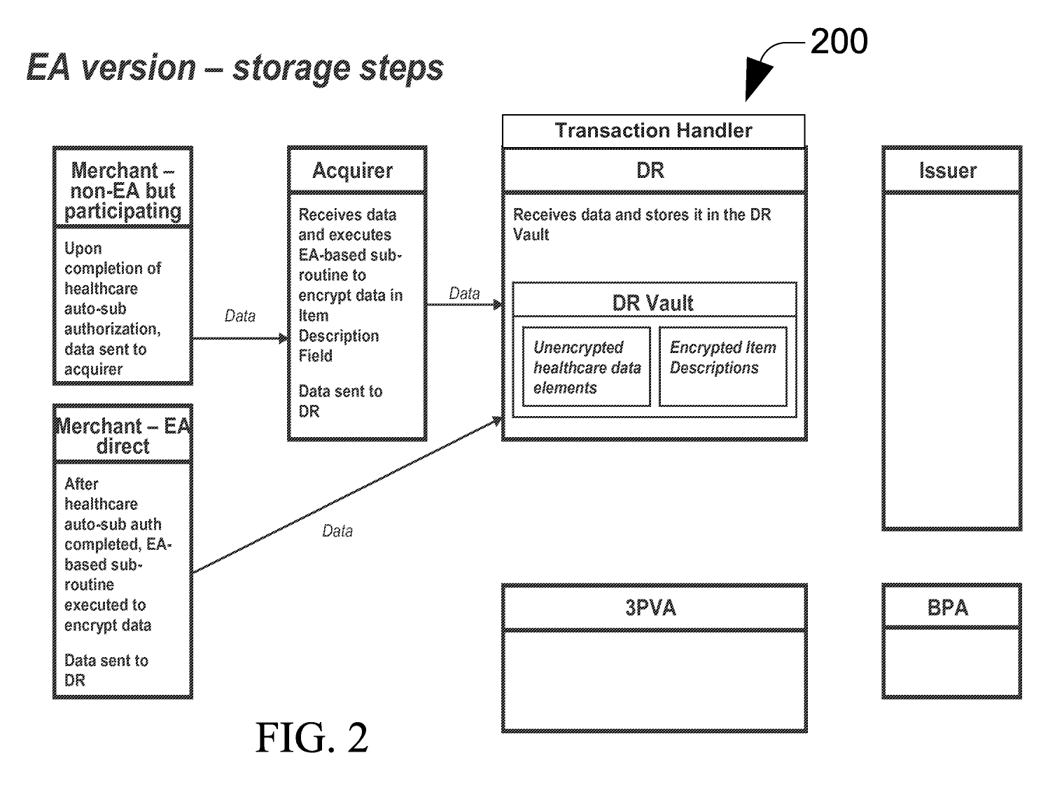

Turning now to FIG. 2, a block diagram 200, labeled “EA version—storage steps”, is presented as an environment for an exemplary implementation of steps that illustrate the storing of the healthcare transaction data with the DR within a DR Vault. For the merchant that is participating in the DR service but does not wish to deploy any Encryption Algorithm (EA) based subroutine, which is illustrated in FIG. 2 as “Merchant non-EA but participating,” the deployment may occur after the completion of a healthcare transaction authorization. In other words, a consumer may purchase goods and/or services from the merchant, and then sometime after the healthcare transaction is authorized for payment, the merchant may batch a number of the healthcare transactions together and submit them to the acquirer of the merchant. The acquirer of the merchant may have an acquirer-merchant based process for receiving the batched healthcare transaction data which may include some form of encryption (e.g., one that complies with HIPAA regulations). The acquirer-merchant based process may have a pre-set frequency for the acquirer to receive the batched healthcare transaction data (e.g., daily, weekly, monthly). The acquirer may then use the EA based subroutine to encrypt the batched healthcare transaction data. The healthcare transaction data can then be sent to the DR for storing in the DR Vault. Therefore, in this implementation, the healthcare transaction data is at least encrypted prior to being sent to the DR.

In another implementation, the direct merchant batches healthcare transaction data that is, at least in part, encrypted using the EA based subroutine (e.g., ECC based subroutine or ECC subroutine). After encryption, the direct merchant has the option to send the encrypted batched healthcare transaction data to the respective acquirer of the direct merchant to forward for storing in the DR. Alternatively, or in combination, the direct merchant may submit the encrypted batched healthcare transaction data for storing in the DR directly, such as by sending the encrypted batched healthcare transaction data to the transaction handler or 3PVA.

The transaction handler may manage the DR Vault, as illustrated in FIG. 2, or alternatively, the 3PVA may manage the DR Vault. If the transaction handler manages the DR Vault, the DR may be integrated into a payment processing system such that existing retrieval systems can be used. For example, issuers of healthcare accounts may use a specific ‘request reason code’ already developed for other transaction data requests (e.g., charge backs, loyalty program statement credit requests) to request healthcare transaction data from the DR Vault.

The 3PVA may manage the DR Vault, in which case the 3PVA may be responsible for storing the healthcare transaction data in a secure manner (e.g., one that complies with HIPAA standards) and for responding to requests by verified participants. Alternatively, the 3PVA may essentially fulfill requests for healthcare transaction data stored in the DR Vault but not store healthcare transaction data in the DR Vault.

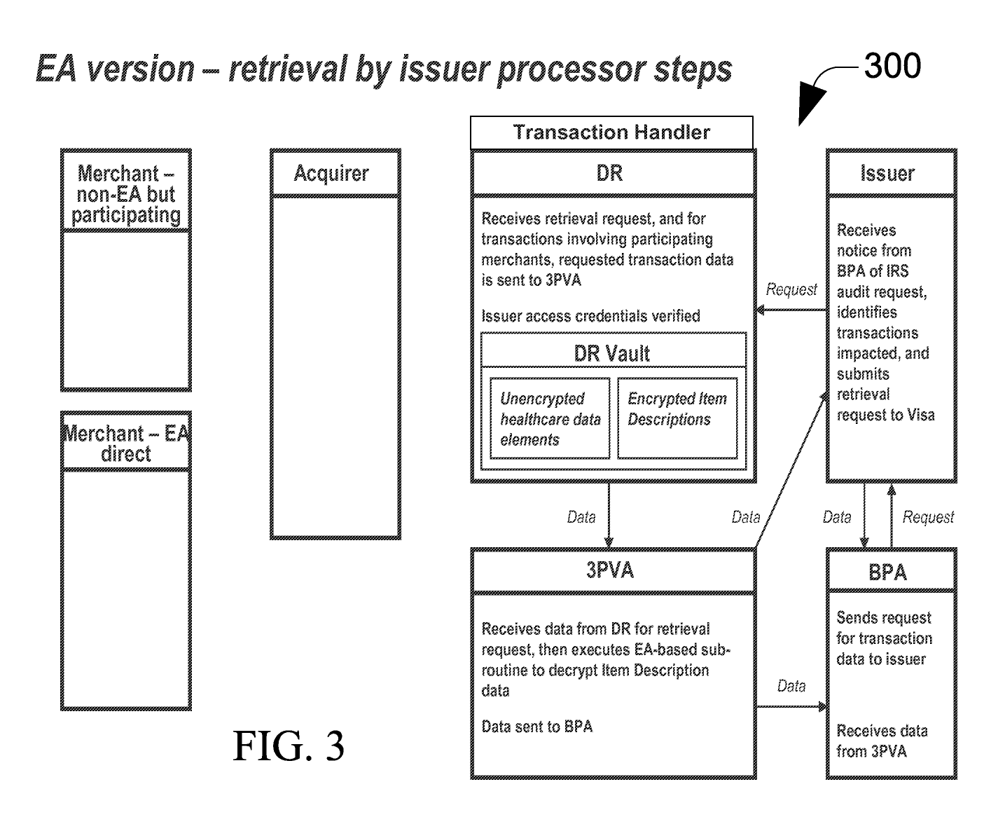

Turning now to FIG. 3, a block diagram 300, labeled “EA version—retrieval by issuer processor steps”, is presented as an environment for an exemplary implementation for data retrieval from the DR Vault. As illustrated in FIG. 3, a Benefit Plan Administrator (BPA), such as an employer, may request data from an issuer of a healthcare account in a Benefit Plan. The issuer may then transmit a request to the DR seeking healthcare transaction data stored in the DR Vault. The issuer may submit healthcare account information to the DR. For example, the issuer may request information for data pertaining to a group of healthcare accounts having a specified Bank Identification Number (BIN) as the first six numbers of each healthcare account in the group.

The DR may transmit the request to the 3PVA. The 3PVA may execute the EA based sub-routine to decrypt the requested healthcare transaction data (e.g., line item description data in a transaction). The healthcare transaction data can then be sent to the BPA directly or sent to the corresponding issuer to forward to the BPA.

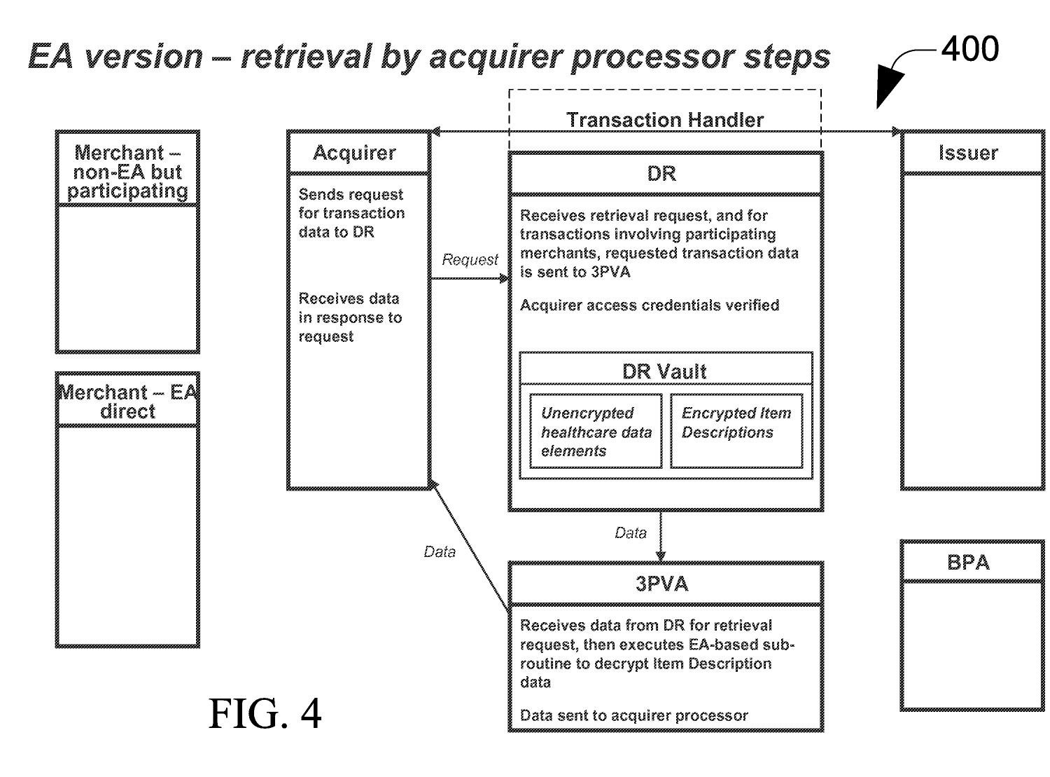

Turning now to FIG. 4, a block diagram 400, labeled “Encryption Algorithm (EA) version—retrieval by acquirer processor steps”, is presented as an environment for an exemplary implementation for data retrieval from the DR Vault. In this case, the acquirer and/or the merchant may initiate the request for data retrieval. FIG. 4 illustrates fulfillment of a request made by an acquirer for healthcare transaction data stored in the DR Vault that the acquirer can legitimately access. Here, the acquirer can send the request for the healthcare transaction data to the DR, the DR can receive the request for transactions involving the corresponding merchants of the requesting acquirer. The transaction handler may forward the request to the 3PVA. The 3PVA may execute EA based sub-routine to decrypt the healthcare transaction data requested. As in the implementation illustrated in FIG. 3 where the issuer must first be validated as having access the requested data prior to receiving the requested data, the acquirer's access credentials would be verified prior to retuning the requested healthcare transaction data back to the acquirer who had requested the data. Once the acquirer receives the requested healthcare transaction data, the acquirer may forward it to merchants having access to the healthcare transaction data or utilize it for the acquirer's purposes. For example, the acquirer may request the healthcare transaction data to help manage the acquirer's business. Alternatively, one of the issuers that is not in the DR program may contact the acquirer to make the request for the healthcare transaction data from the nonparticipating issuer. In this case, the acquirer may send the healthcare transaction data to the nonparticipating issuer after receiving it from the 3PVA or the transaction handler. The issuer may then use the healthcare transaction data as part of an audit response of the IRS, or to provide a year-end summary for its healthcare account holders, or for an employer's employees. To illustrate, the issuer may submit a year end summary delineating all the goods and/or services that a particular employee purchased using a corresponding FSA account during open enrollment for the FSA plan.

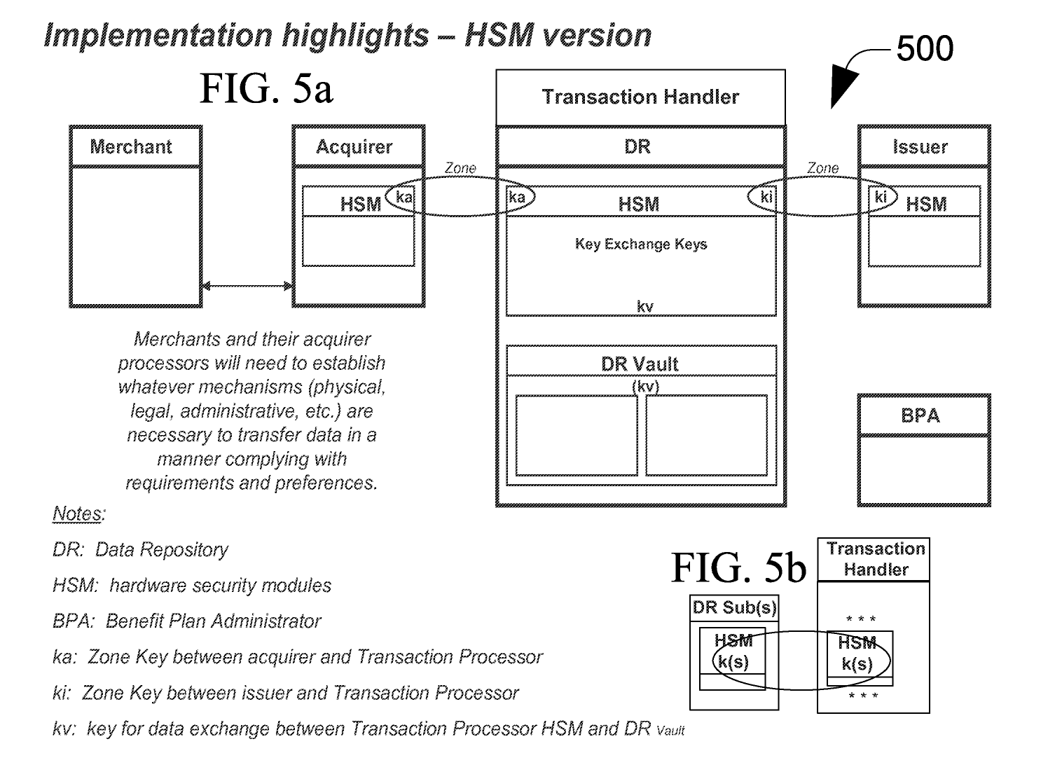

FIGS. 5-11 depict various abbreviations which are DR: Data Repository; HSM: Hardware Security Module; BPA: Benefit Plan Administrator; ka: Zone Key between an acquirer and a transaction handler; ki: Zone Key between an issuer and a transaction handler; kv: key for data exchange between the HSM and the DR Vault.

In another implementation, an example of which is seen in FIG. 5a, a healthcare transaction processing and storage implementation involves a Data Repository (DR) which may be hosted by the transaction handler within the payment processing system or via a third party processor. The DR addresses the desirability to provide secure data storage and retrieval requirements for confidential information. The DR stores healthcare auto-substantiation transaction data, along with their product line item detail, for participating merchants, to facilitate access to this information. The DR can securely store and transmit the data, which is considered ePHI and therefore subject to HIPAA requirements, in a manner that complies with HIPAA. In this implementation, the DR relies on hardware security modules (HSM) to provide cryptographic protection of ePHI within the storage and retrieval processes for healthcare auto-substantiation transaction data. HSMs encrypt and decrypt data using cryptographic keys secured within the hardware. The HSMs do not allow these keys (private keys) to be disclosed.

Each participating acquirer processor and issuer processor would have a deployed HSM. The transaction handler may also have a deployed HSM for an application system and/or a storage unit, referred to as a DR Vault, where participating merchants' data would be stored. This DR Vault would generate all cryptographic keys used in this implementation, including Zone Keys (Bundled Triple Data Encryption Standard (TDES) Keys), Master Keys, and Key Exchange Keys (KEK). Each participating acquirer processor and issuer processor would have a Zone Key established with the transaction handler.

The storage process starts after the transaction handler authorization has been approved and captured by the merchant. The merchant sends a predefined data set, including basic transaction data and product line item detail associated with the transaction, to its acquirer processor, or the merchant may send the data set to the transaction handler directly. The data is considered ePHI (i.e., private information) because it includes enough information to identify the individual account holder or cardholder (e.g., consumer), as well as to identify purchases made by the individual's FSA or HSA payment card, for example.

The acquirer processor will receive the data and, using its HSM and the Zone Key (ka) established between itself and transaction handler, will encrypt all data in the Item Description Field of the received healthcare auto-substantiation transaction data sets. Some data may be sensitive and encrypted. Some data may not need to be protected and left unencrypted. Yet all data could be determined to be sensitive and encrypted. For example, only the Item Description Field may be encrypted but the date of the transaction may be left unencrypted. As such the Zone Key (ka) is used for secure communications between the acquirer and the transaction handler.

The DR would then instruct the transaction handler HSM to execute data input procedures for the received data from the acquirer processor. The transaction handler HSM, using Key Exchange Keys, can convert the encryption method for the encrypted Item Descriptions from Zone Key ka to kv (key for data exchange between the transaction handler and the DR Vault), which is the key established between the transaction handler HSM and the transaction handler DR Vault. This data, with newly encrypted Item Descriptions and its associated other transaction data elements, is securely stored in the DR Vault.

These handling procedures can comply with HIPAA requirements for ePHI, and comport with security standards established and recommended by the National Institute of Standards & Technology (NIST) Key Management Guidelines. The Key Exchange Keys provide protection for all keys in this implementation, and can be implemented so as to be recognized by the NIST for protecting sensitive data throughout this implementation.

The retrieval process starts when a legitimate authority, such as a Data Repository (DR) Subscriber, issues a retrieval request for specific data records. The DR subscriber will formulate the request/query in a manner necessary to retrieval all required data.

Turning now to FIG. 5a, a block diagram 500, labeled “Implementation highlights—HSM version”, is presented as an environment for an exemplary implementation in which an application for a DR, or DR application, will receive a request for specific transaction data and send the requested data to an HSM for a transaction handler. The HSM will execute data output procedures for the data to be sent to a DR Subscriber that requested the specific transaction data. The transaction handler HSM, using Key Exchange Keys, will convert the encryption method for the encrypted Item Descriptions from kv to the Zone Key of the DR Subscriber (e.g., “ki” or “ka” in FIG. 5), which is established between the requestor and the transaction handler. This data, with newly encrypted Item Descriptions and its associated unencrypted other transaction data elements, is then sent to the DR Subscriber that requested the specific transaction data.

A DR Subscriber, shown in FIG. 5b as ‘DR Sub(s), will receive the data and, using its HSM and Zone Key, (k(s)), established between itself and transaction handler whose HSM also hast the same Zone Key, (k(s)), will decrypt all data in the Item Description Fields of the received transaction data set. Note that the HSM of the transaction handler can have Zone Keys from k(1) to K(S), where S is a large integer, and where k(s) is a Zone Key used by the transaction handler and any particular DR Subscriber from secure communications from the transaction handler to DR Subscriber k(s).

DR Network Set-Up.

In one implementation, the following primary roles and responsibilities can be assumed for each DR network participant:

| | |
|---|---|
| Merchants | Submit Receipt Detail to their acquirer/processor, |
| | as well as make all other legal, technical, and business |
| | process arrangements necessary to enable the data transfer. |
| Acquirer/ | Encrypt Item Description data from their participating |
| processors | merchants using a DR HSM and include the encrypted Item |
| | Description data in Receipt Detail submissions to the DR. |
| Issuer/ | Submit retrieval requests for Receipt Detail, in support |
| processors | of their Benefit Plan Administrator customers who are |
| | responding to audit requests of their corporate employer |
| | clients, to a transaction handler for processing. |
| | Decrypt encrypted Item Descriptions in Receipt Detail |
| | records, and send this data to their customers to fulfill |
| | audit requests. |
| Transaction | Store Receipt Detail on behalf of acquirer/processors and |
| handler | their merchants. |
| | Retrieve Receipt Detail within the DR when requested by |
| | authorized issuers/processor or acquirer/processors. |
| | Route retrieval requests from issuer/processors to |
| | acquirer/processors when Receipt Detail in question is |
| | not part of the DR. |

For example of DR participation:

| | |
|---|---|
| All participants | May be a member of Special Interest Group for IIAS |
| | Standards (SIGIS), an industry trade group of which |
| | transaction handler is a founding member. SIGIS has |
| | established standards for transaction processing of FSA/ |
| | HSA accounts (e.g., cards) that comply with IRS rules. |
| Acquirer/ | May have certified to a transaction handler's |
| processors | healthcare auto-substantiation processing standards. |
| | May integrate and implement an HSM-based crypto- |
| | graphic component to secure healthcare data according |
| | to DR standards. |
| | May accept DR Terms of Service Agreement. |
| Issuer/ | May participate in a DR if they have a transaction |
| processors | handler's Bank Identification Numbers (BINS) for |
| | FSA/HSA accounts. |
| | May integrate and implement an HSM-based crypto- |
| | graphic component to secure healthcare data according |
| | to DR standards. |
| | May accept DR Terms of Service Agreement. |
| Merchants | May have been SIGIS technically certified by their |
| | acquirer/processor. |

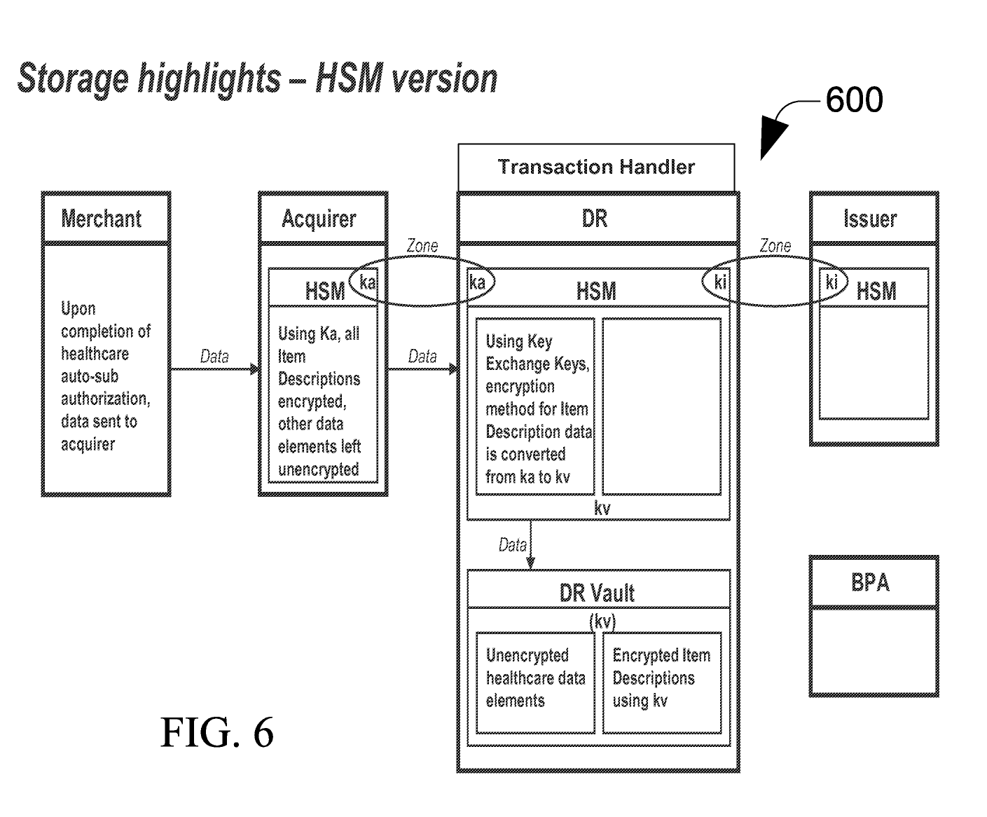

Turning now to FIG. 6, a block diagram 600, labeled “Storage highlights—HSM version”, is presented as an environment for an exemplary implementation in which enhanced healthcare transaction data, which has been auto-substantiated data, is stored and delivered to participants. Data records in this data, referred to as “Receipt Detail”, are comprised of two types of data: (i) Transaction Data; and (ii) Product Data. The Transaction Data includes information on the transaction itself, such as Transaction ID, Date, Amount, Account Number, Merchant Name and Address, and other related data. The Product Data includes information on the item(s) purchased on the FSA/HSA account, such as Item Description (also known as Product Description), Item Count, and Item Cost.

The Item Descriptions, if required to comply with HIPAA regulations, can be encrypted by the acquirer/processor prior to being submitted to the DR. The remaining data elements, optionally, may not be encrypted. The Receipt Detail, including the encrypted Item Descriptions, can reside in the DR.

The DR will preferably rely on hardware security modules (HSM) to provide cryptographic protection of ePHI within the storage and retrieval processes for healthcare auto-substantiation transaction data. HSMs encrypt and decrypt data using cryptographic keys secured within the hardware. HSMs do not allow private keys to be disclosed. Each participating acquirer/processor and issuer/processor would have a deployed HSM.

The transaction handler also would have a deployed HSM for its application system. The transaction handler would also have a storage unit, referred to as a DR Vault, where participating merchants' data would be stored. The DR Vault would generate all cryptographic keys used in this implementation, including Zone Keys (Bundled TDES Keys), Master Keys, and Key Exchange Keys (KEK). The same private keys, for service quality assurance, will preferably be stored in a redundant fashion, in multiple HSMs, in multiple locations within the transaction handler. Each participating acquirer/processor and issuer/processor would have a Zone Key established with the transaction handler, for use in encryption/decryption of data exchanged with the transaction handler.

Subscription files can be developed and delivered to an Application Team Member using the data elements. Subscription files will preferably be populated with inputs from a registration form to be developed by the transaction handler.

The storage process starts after a healthcare auto-substantiation authorization has been approved and captured by the merchant. All account types can be supported, not just the transaction handler's accounts. The merchant sends a predefined data set, including basic transaction data and product line item detail associated with the transaction, to its acquirer/processor. The data is considered ePHI because it includes enough information to identify the individual account holder (e.g., a patient receiving healthcare goods and/or services who is a cardholder) as well as purchases made by the account holder's use of a payment card corresponding to their health-related account(s) (e.g., FSA, HSA, etc.) for healthcare or medical products and/or services. This exchange of data between the merchant and its acquirer/processor will use methods and mechanisms to be determined by the parties in order to comply with legal and regulatory requirements and organizational preferences.

The acquirer/processor will receive the data and, using its HSM and the Zone Key (ka) established between it and the transaction handler, will encrypt all data in the Item Description Field of the healthcare auto-substantiation transaction data sets received. All other data in the transaction record can remain unencrypted as if may not be required to be so because is does not represent ePHI.

At a predetermined frequency and using protocols, processes, and file formats previously defined, the participating acquirer/processors will submit Receipt Detail, including both unencrypted and encrypted data fields, to a transaction handler via a transaction handler secure file transmission service (e.g., an OFD or FES connection). The transaction handler will route the files to the DR application system.

The DR would then instruct the transaction handler HSM to execute data input procedures for the received data from the acquirer/processor. The transaction handler HSM, using Key Exchange Keys, will convert the encryption method for the encrypted Item Descriptions from Zone Key ka to kv, which is the key established between the transaction handler HSM and the transaction handler DR Vault. This data, with newly encrypted Item Descriptions and its associated other transaction data elements, is securely stored in the DR Vault.

Procedures for this implementation will preferably comport with security standards established and recommended by the National Institute of Standards & Technology (NIST) Key Management Guidelines. The Key Exchange Keys provide protection for all keys in this implementation. The transaction handler will not be able to access the data because the private keys will remain in the HSM.

In another implementation, the encrypted Item Descriptions may have the following characteristics:

Data Model
The fields for Item Description can be expanded to handle data expansion related to the deployed encryption method used by the merchant or acquirer/processor.

Field Record Specifications

The field formats and lengths in the files related to the Item Descriptions can be modified.

Request for Data

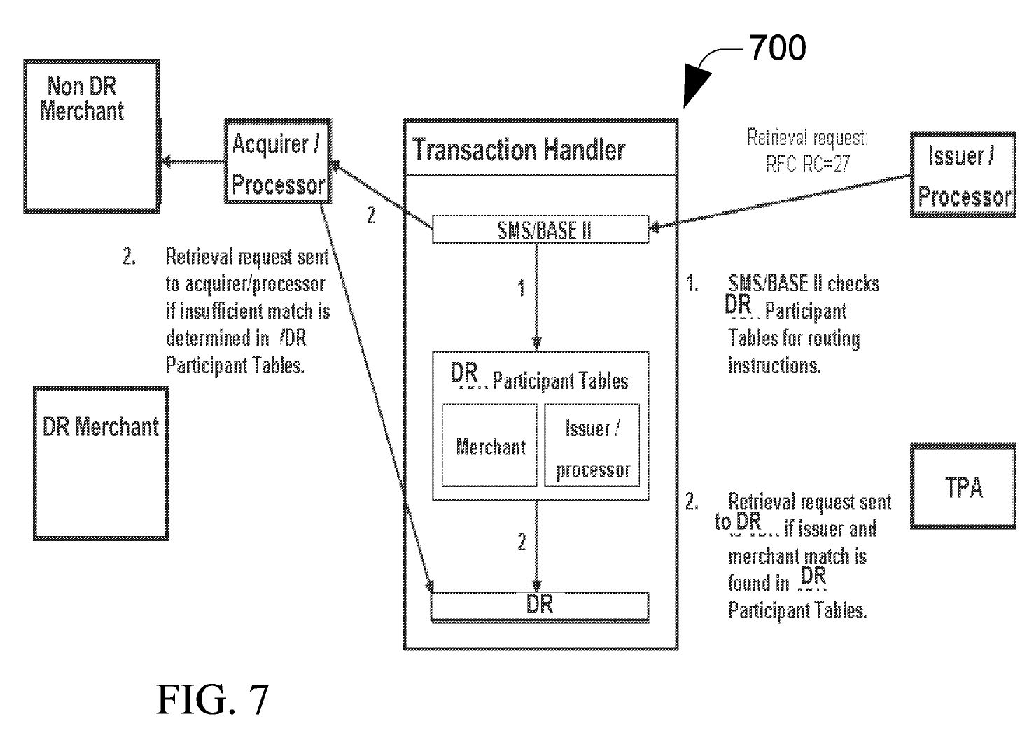

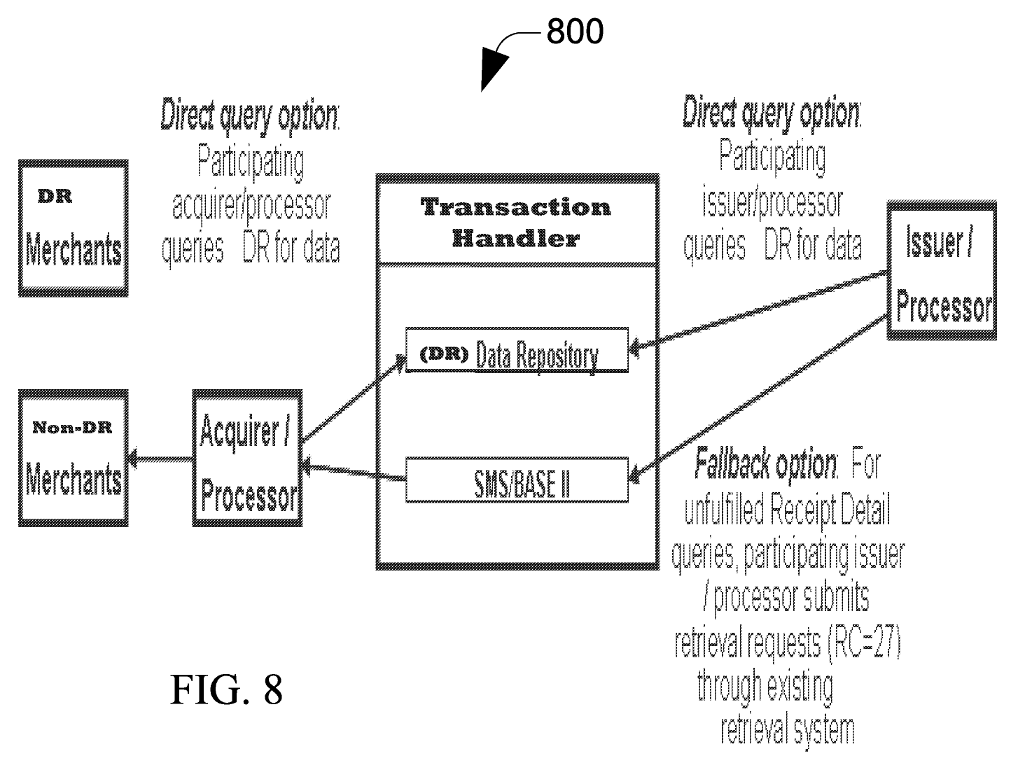

Referring now to FIGS. 7-8, implementations provide two basic retrieval request approaches:
DR integrated into existing the transaction handler retrieval systems
DR not integrated into the transaction handler retrieval systems—direct DR queries enabled (for example, the ‘Visa Online’ (VOL) product of Visa Inc.)

A retrieval message can signify a request for enhanced healthcare transaction data (i.e., Receipt Detail) likely in response to an audit request of an employer with an FSA benefit card program for its employees. Issuer/processors and acquirer/processors can modify their legacy application systems to process these requests according to one implementation.

Existing procedures can be used to process these retrieval requests in the absence of a DR, such as electronic messaging-based fulfillment of Receipt Detail. These procedures can remain in place to handle implementations where the issuer/processor, acquirer/processor, or merchant are not participating as a DR subscriber. Electronic messaging-based fulfillment may be used in order to comply with HIPAA under these circumstances. Also note that batch requests can be supported under either implementation.

In the DR integration implementation with existing the transaction handler retrieval systems, the DR Participant Tables can to be created to determine whether forwarding to the DR for retrieval processing is warranted. The DR Participant Tables can have all DR Participants listed in it, including issuer/processors and merchants.

Under varying circumstances in this DR integration implementation, as shown in FIG. 7, acquirer/processors can query and retrieve Receipt Detail from the DR on behalf of their participating merchants. The processing starts upon receipt of an SMS or BASE II message, known in the Visa Inc. financial messaging system as a ‘RFC RC 27’ message, which prompts a checking of the DR Participant Tables. Stated otherwise, there is a submission of a RFC RC 27 to SMS/BASE II. There are four possible outcomes from this table look-up function, summarized in Table 2 below:

TABLE 2
Look-Up Function Outcomes - Integration Implementation

| | | Issuer/Processor Participation in DR | |
|---|---|---|---|
| | | Yes | No |
| Acquirer/ | Yes | A) DR used for | B) DR used to retrieve |
| Merchant/ | | retrieval processing | merchant's data only by |
| Processor | | | participating Acquirer |
| Participation | | | querying it; existing e- |
| in DR | | | messaging procedure used |
| | | | by acquirer or merchant |
| | | | to fulfill Receipt Detail |
| | | | Request |
| | No | C) DR not used for | D) DR not used for |
| | | retrieval processing, | retrieval processing, |
| | | existing retrieval | existing retrieval |
| | | procedures used | procedures used |

Under condition A in Table 2 above, the Participant Table look-up discovers that the issuer/processor is participating currently and the merchant is participating as of the date of the transaction request specified. The RFC RC 27 is then converted to a DR query and processed by the DR. Data integrity checks must be undertaken to confirm the validity of the RFC RC 27 conversion. If this check fails, then the retrieval request should be send to the acquirer/processor to continue retrieval processing. After a successful query, the DR then returns the result to the issuer/processor and executes instructions to send the requested data to the issuer/processor (described later in this document in “Fulfillment” Section).

Under condition B in Table 2 above, the Participant Table look-up discovers that the issuer/processor is not participating in the DR. The RFC RC 27 is then sent to the acquirer/processor and continues routine retrieval processing. Because the merchant is participating in the DR during the time period indicated, the acquirer/processor queries the DR to retrieve the Receipt Detail and fulfills the request using existing fax method.

Under condition C in Table 2 above, the Participant Table look-up discovers that the issuer/processor is participating currently, but that the merchant as of the date indicated is not participating in the DR. The RFC RC 27 is sent to the acquirer/processor and continues routine retrieval processing. Because the merchant is not participating in the DR during the time period indicated, the merchant uses existing retrieval methods and electronically messages (i.e., facsimile, e-mail, texting, etc.) the Receipt Detail to the address provided in the request message.

Under condition D in Table 2 above, the Participant Table look-up discovers that neither the issuer/processor nor the merchant is participating in the DR. The RFC RC 27 is sent to the acquirer/processor and continues retrieval request processing. Because the merchant is not participating in the DR during the time period indicated, the merchant uses existing retrieval methods and fulfills the Receipt Detail via fax.

Another implementation is a Data Repository (DR) non-integration implementation, where direct DR queries are enabled via an online system, such as the Visa On-Line service (VOL) provided by Visa, Inc. Under this implementation as shown in FIG. 8, there is no integration of the transaction handler SMS/BASE II retrieval systems with the DR. There is no DR Participant Table, no DR Participant Table look-up function, and no forwarding of retrieval requests to the DR. The DR in this implementation acts as a first-use, cost effective option and resource for issuer/processors and acquirer/processors, who directly query the DR to request healthcare transaction data using an online system of the transaction handler, such as the Visa Online (VOL) service of Visa Inc.

The data request for issuer/processors and acquirer/processors fall into two main implementations: (i) General inquiry for supported customers; and (ii) Audit request inquiry for specific healthcare auto-substantiation transactions.

The general inquiry implementation takes the form of an acquirer/processor querying the DR for data associated with its merchants that are participating in the DR, or an issuer/processor querying the DR for data associated with its cardholders that are participating in the DR. The research associated with the general inquiry may or may not be related to a specific healthcare auto-substantiation transaction.

The audit request inquiry implementation allows an issuer/processor to query the DR directly for healthcare data it is entitled to access, without submitting an RFC RC 27 to the transaction handler through the existing retrieval systems (i.e., SMS/BASE II).

Both the of the two main implementations, general inquiry for supported customers for issuer/processors and for acquirer/processors, and also the audit request inquiry for specific healthcare auto-substantiation transactions will preferably use a search algorithm that will check for merchant participation for requested transactions.

Credential checking functionality will preferably be incorporated into the inquiry function to determine access rights and privileges to data by requesting entitles. Screen prompts and application logic will preferably allow for issuer/processors and acquirer/processors to access cardholder and merchant data, respectively, that they are entitled to access. The online system of the transaction handler will preferably provide access and credential checking functionality for issuer/processors and acquirer/processors.

Issuer/processors and acquirer/processors will preferably be provided with a capability to view individual Receipt Detail records through a transaction handler interface. Also, acquirer/processors can be enabled to participate in both the general inquiry implementation and the audit request inquiry implementation. For audit request inquiries, the issuer/processor can be provided with retrieval processing options based on whether parties involved in the retrievals (issuer and merchant) are participating in the DR or not, which are summarized in yet another implementation characterized in Table 3 and showing outcomes for audit request inquiries in an non-integration implementation:

TABLE 3

| | | Issuer/Processor Participation | |
|---|---|---|---|
| | | Yes | No |
| Acquirer/ | Yes | A) DR used for | B) DR not used to |
| Merchant/ | | retrieval processing | retrieval processing; |
| Processor | | | existing retrieval/fax |
| Participation | | | procedures used |
| | No | C) DR queried but | D) DR not used to |
| | | unsuccessful, existing | retrieval processing; |
| | | retrieval procedures | existing retrieval/fax |
| | | used | procedures used |

Under condition A in Table 3 above, the issuer/processor, due to its DR participant status, queries the DR for records required. Because the merchant is participating during the time period indicated, the Receipt Detail is retrieved from the DR. The DR returns the results to the issuer/processor (described later in the “Fulfillment” Section).

Under condition B in Table 3 above, the issuer/processor cannot query the DR because it is not a participant. Rather, those results are communicated back to the issuer/processor. The issuer/processor must submit a RFC RC 27 to SMS/BASE II, and the retrieval request is sent to the acquirer/processor for retrieval processing with an electronic message delivery of Receipt Detail.

Under condition C in Table 3, above, the issuer/processor queries the DR for records due to its DR participant status. Because the merchant involved is not participating during the time period indicated in the DR, the DR query is unsuccessful, and those results are communicated back to the issuer/processor. The issuer/processor can now submit a RFC RC 27 to SMS/BASE II, and the retrieval request is sent to the acquirer/processor for retrieval processing with electronic message delivery of Receipt Detail.

Under condition D in Table 3 above, the issuer/processor cannot query the DR because it is not a participant. The issuer/processor must submit a RFC RC 27 to SMS/BASE II, and the retrieval request is sent to the acquirer/processor for retrieval processing with fax delivery of Receipt Detail. See FIG. 8 which shows, at reference numeral 800, an exemplary implementation for audit retrieval requests under DR non-integration, with: (i) a direct query option in which a participating acquirer/processor queries a DR for data; (ii) a direct query option in which a participating issuer/processor queries a DR for data; and (iii) a fallback option for unfulfilled Receipt Detail queries in which a participating issuer/processor submits retrieval requests (RC-27) through an existing retrieval system, such as that of a transaction handler (i.e., Visa, Inc.). Batch file delivery can be supported in this implementation.

Fulfillment

Still another implementation involves the fulfillment of data requests. Fulfillments from the DR will send requested data to issuer/processors or to acquirer/processors, and will utilize similar procedures.

To Issuer/Processors

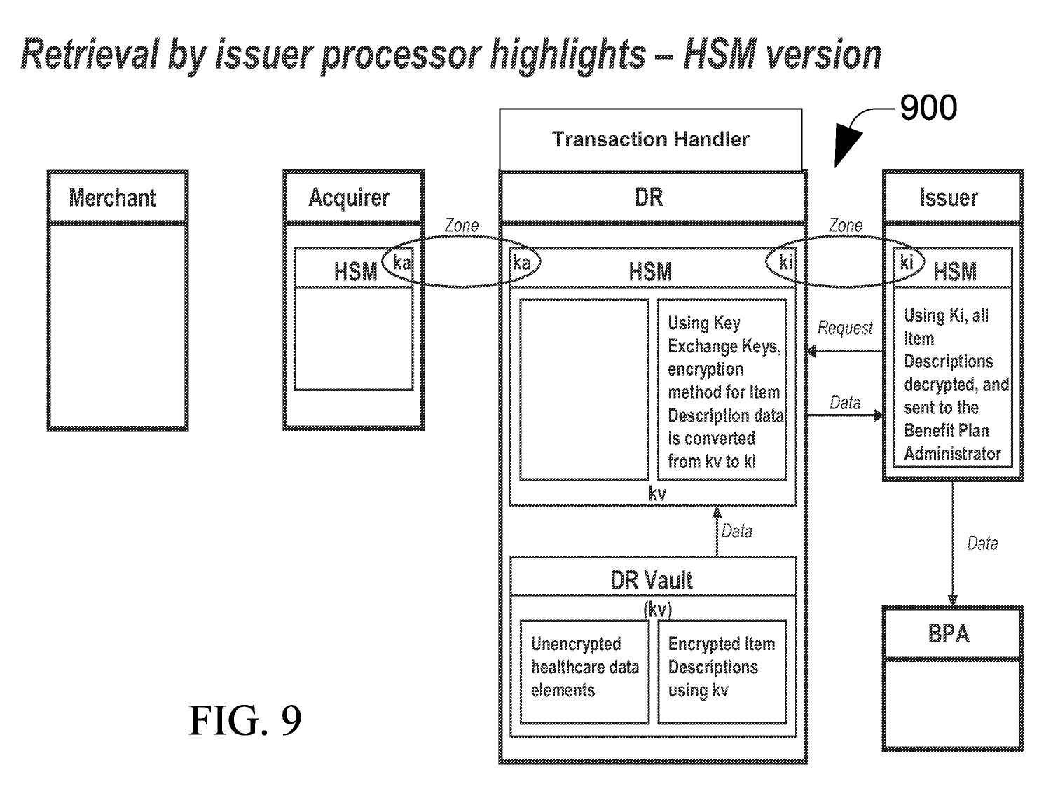

Referring now to FIG. 9, labeled “Retrieval by issuer processor highlights—HSM version”, the DR instructs the transaction handler HSM to execute data output procedures to send the data to the issuer processor. The transaction handler HSM, using Key Exchange Keys, will convert the encryption method for the encrypted Item Descriptions from kv to Zone Key ki, established between the requesting issuer/processor and the transaction handler. This data, with newly encrypted Item Descriptions and its associated unencrypted other transaction data elements, is then sent to the issuer/processor. The issuer/processor will receive the data and, using its HSM and the Zone Key (ki) established between it and the transaction handler, will decrypt all data in the Item Description Fields. The fulfillment of Receipt Detail for a data request to the issuer/processor by the DR is summarized in FIG. 9, and particularly showing highlights of a Hardware Security Module (HSM) version for retrieval to the issuer processor.

To Acquirer/Processors

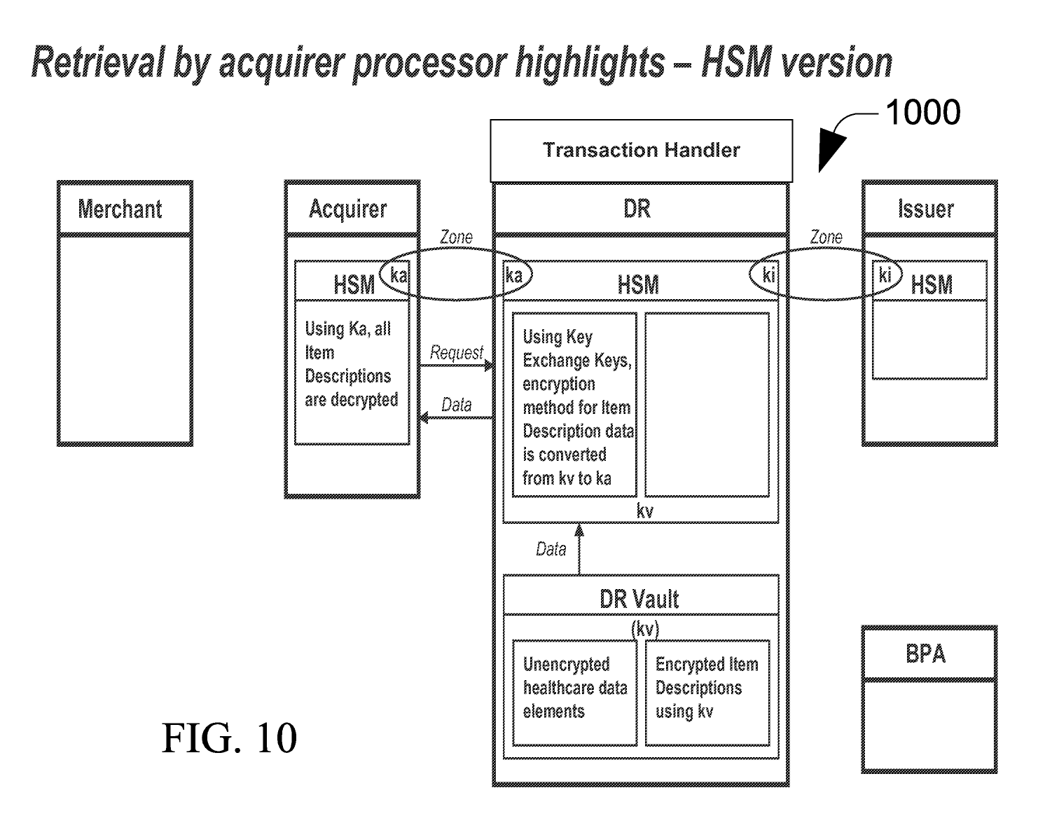

Referring now to FIG. 10, labeled “Retrieval by acquirer processor highlights—HSM version”, there is depicted an implementation in which the DR instructs the transaction handler HSM to execute data output procedures for the data to be sent to the acquirer/processor. The transaction handler HSM, using Key Exchange Keys, will convert the encryption method for the encrypted Item Descriptions from kv to Zone Key ka, established between the requesting acquirer processor and the transaction handler. This data, with newly encrypted Item Descriptions and its associated unencrypted other transaction data elements, is then sent to the acquirer/processor. The acquirer/processor will receive the data and, using its HSM and the Zone Key (ka) established between it and the transaction handler, will decrypt all encrypted data in the Item Description Fields of the received transaction data set. An exemplary fulfillment of Receipt Detail data request to the acquirer/processor by the DR is seen in FIG. 10, and specifically showing highlights of a retrieval by the acquirer processor for the Hardware Security Module (HSM) version.

Reporting may be made to reflect the fact that portions of Receipt Detail will be unreadable. The encrypted Item Descriptions will appear as an encrypted data mass in a string of alphanumeric characters, and this data will be unreadable whether displayed for a user (e.g., via CDI/MI interface) or sent via formatted report to a user. Report and file export formats will preferably accommodate increased space requirements for this encrypted data.

In one implementation, both issuers and acquirer/processors can be provided with interfaces to Receipt Detail reports or data, and well as mechanisms and tools for regular scheduled report generation and delivery, ad-hoc report generation and delivery, and inquiry tools. As such, acquirer/processors can access data, reports, etc., in the same manner as issuer/processors.

For all fulfillments of Receipt Detail not performed by the DR, existing retrieval fulfillment procedures will preferably be used, which utilize electronic message transmission methods that are HIPAA-compliant.

In a still further implementation, the DR Vault seen in FIGS. 5-11 can receive data from a merchant seen in FIGS. 1-4, where the merchant sends encrypted transaction data formed by a software implemented encryption algorithm. As such, the acquirer need not send encrypted data from a transaction to the vault, but only needs to send non-sensitive information (data not consider ePHI) to the transaction hander. Once the merchant encrypted transaction data is received by the vault, is unencrypted and the stored in the vault using the key for data exchange between the transaction handler (e.g., transaction processor HSM and the Data Repository as described above. As such, the hybrid implementation of both a software encryption algorithm, such as ECC, with an Hardware Security Module is contemplated for storage of ePHI in the vault.

Cryptographic Summary

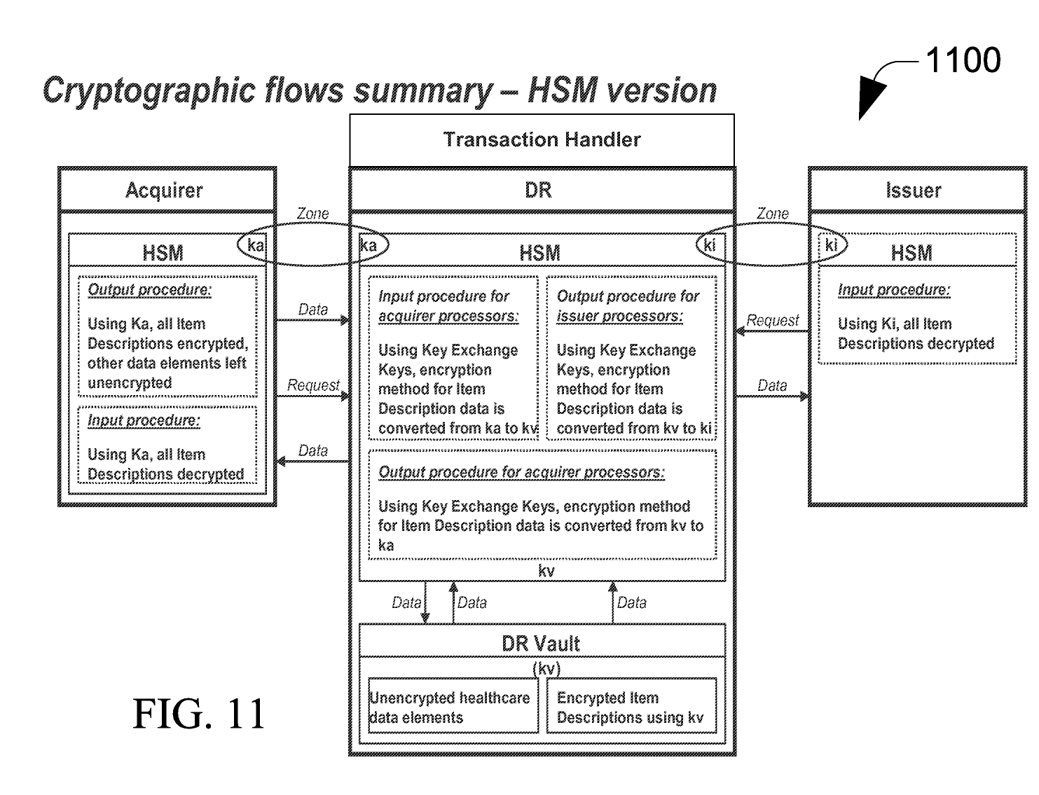

Cryptography will preferably be used to secure Receipt Detail records both in transit and at rest in the DR Solution. The deployment of HSMs, which will prevent unauthorized disclosure or access to private information within the Receipt Detail data records, can use any well-understood data security model that will be suitable for use by each of the transaction handler, acquirer/processors, and issuer/processors. FIG. 11 summarizes cryptographic flows pertaining to a DR Solution for the Hardware Security Module (HSM) version. The HSMs can utilize a security standard from the Federal Information Processing Standard, called FIPS-Level 3. A description of this Level 3 Security is included below:

FIPS 140-2 Security Levels

FIPS 140-2 defines four levels of security, simply named “Level 1” to “Level 4”. It does not specify in detail what level of security is required by any particular application.

Level 1

Security Level 1 provides the lowest level of security. Basic security requirements are specified for a cryptographic module (e.g., at least one Approved algorithm or Approved security function shall be used). No specific physical security mechanisms are required in a Security Level 1 cryptographic module beyond the basic requirement for production-grade components. An example of a Security Level 1 cryptographic module is a personal computer (PC) encryption board.

Level 2

Security Level 2 enhances the physical security mechanisms of a Security Level 1 cryptographic module by adding the requirement for tamper-evidence, which includes the use of tamper-evident coatings or seals or for pick-resistant locks on removable covers or doors of the module. Tamper-evident coatings or seals are placed on a cryptographic module so that the coating or seal must be broken to attain physical access to the plaintext cryptographic keys and Critical Security Parameters (CSPs) within the module. Tamper-evident seals or pick-resistant locks are placed on covers or doors to protect against unauthorized physical access.

Level 3

In addition to the tamper-evident physical security mechanisms required at Security Level 2, Security Level 3 attempts to prevent the intruder from gaining access to CSPs held within the cryptographic module. Physical security mechanisms required at Security Level 3 are intended to have a high probability of detecting and responding to attempts at physical access, use or modification of the cryptographic module. The physical security mechanisms may include the use of strong enclosures and tamper detection/response circuitry that ‘zero-izes’ all plaintext CSPs when the removable covers/doors of the cryptographic module are opened. Note that the transaction handler HSMs will preferably be run at FIPS 140-2 Level 3.

Level 4

Security Level 4 provides the highest level of security. At this security level, the physical security mechanisms provide a complete envelope of protection around the cryptographic module with the intent of detecting and responding to all unauthorized attempts at physical access. Penetration of the cryptographic module enclosure from any direction has a very high probability of being detected, resulting in the immediate ‘zero-ization’ of all plaintext CSPs. Security Level 4 cryptographic modules are useful for operation in physically unprotected environments. Security Level 4 also protects a cryptographic module against a security compromise due to environmental conditions or fluctuations outside of the module's normal operating ranges for voltage and temperature. Intentional excursions beyond the normal operating ranges may be used by an attacker to thwart a cryptographic module's defenses. A cryptographic module is required to either include special environmental protection features designed to detect fluctuations and ‘zero-ize’ CSPs, or to undergo rigorous environmental failure testing to provide a reasonable assurance that the module will not be affected by fluctuations outside of the normal operating range in a manner that can compromise the security of the module.

General Implementation Parameters

In certain implementations, individual blocks (or steps) described above with respect to the Figures may be combined, eliminated, or reordered. In certain implementations, instructions are encoded in computer readable medium where those instructions (e.g., software) are executed by a computing apparatus to perform one or more of the blocks (or steps). In certain implementations, individual steps described above in relation to the figures may be combined, eliminated, or reordered. In yet other implementations, instructions reside in any other computer program product, where those instructions are executed by a computing apparatus external to, or internal to, a computing system to perform one or more of the blocks seen in the figures. In either case the instructions may be encoded in a computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, compactflash, smartmedia, and the like.

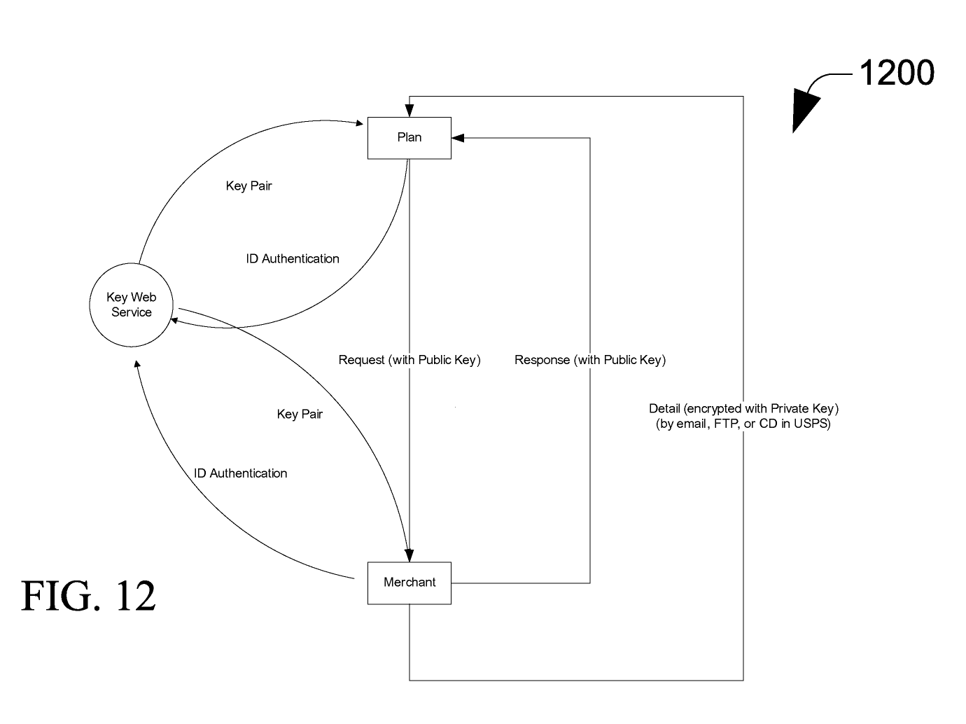

FIG. 12 depicts a flowchart showing a request, a response, and key and identification authentication for secure data transfer between a plan and merchant through a Key Web Service, where the plan can be operated by a Benefit Plan Administrator (BPA), such as an employer, who may request data from an issuer of an healthcare account in the plan.

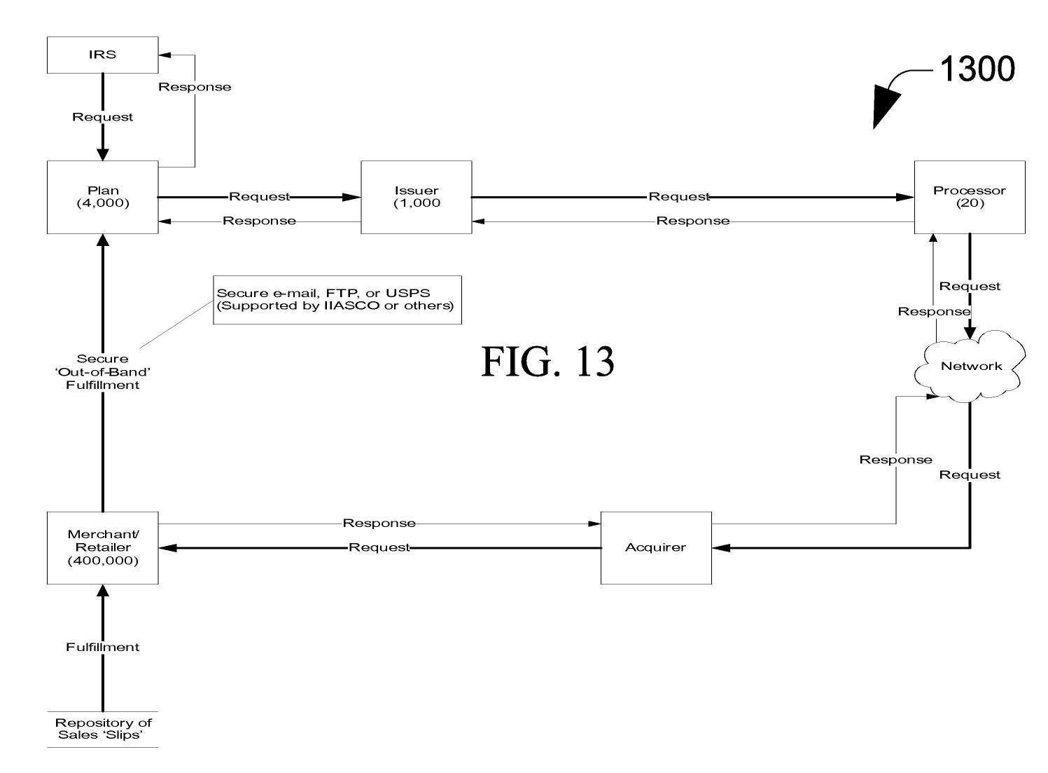

FIG. 13 depicts a flowchart depicting movement of a request by a plan and a response by a merchant/retailer among a plan and entities of a payment processing network more fully described with respect to FIG. 14 as a transaction processing system 1400. Also shown is a repository of sales ‘slips’ submitted for fulfillment to the merchant/retailer, and a request by an entity outside the payment processing network (e.g., the Internal Revenue Service (IRS)) making a request to the plan and receiving a response to the request. Note that the plan in FIG. 13 can be operated by a Benefit Plan Administrator (BPA), such as an employer, who may request data from an issuer of an healthcare account in the plan.

An Exemplary Transaction Processing System

Referring to FIG. 14, a transaction processing system 1400 is seen. The general environment of FIG. 14 include that of a merchant (m) 1410, such as the merchant, who can conduct a transaction for goods and/or services with an account user (au) (e.g., consumer) on an account issued to an account holder (a) 1408 by an issuer (i) 1404, where the processes of paying and being paid for the transaction are coordinated by at least one transaction handler (th) 1402 (e.g., the transaction handler) (collectively “users”). The transaction includes participation from different entities that are each a component of the transaction processing system 1400.

The transaction processing system 1400 may have at least one of a plurality of transaction handlers (th) 1402 that includes transaction handler (l) 1402 through transaction handler (TH) 1402, where TH can be up to and greater than an eight digit integer.

The transaction processing system 1400 has a plurality of merchants (m) 1410 that includes merchant (l) 1410 through merchant (M) 1410, where M can be up to and greater than an eight digit integer. Merchant (m) 1410 may be a person or entity that sells goods and/or services. Merchant (m) 1410 may also be, for instance, a manufacturer, a distributor, a retailer, a load agent, a drugstore, a grocery store, a gas station, a hardware store, a supermarket, a boutique, a restaurant, or a doctor's office. In a business-to-business setting, the account holder (a) 1408 may be a second merchant (m) 1410 making a purchase from another merchant (m) 1410.

Transaction processing system 1400 includes account user (l) 1408 through account user (AU) 1408, where AU can be as large as a ten digit integer or larger. Each account user (au) conducts a transaction with merchant (m) 1410 for goods and/or services using the account that has been issued by an issuer (i) 1404 to a corresponding account holder (a) 1408. Data from the transaction on the account is collected by the merchant (m) 1410 and forwarded to a corresponding acquirer (a) 1406. Acquirer (a) 1406 forwards the data to transaction handler (th) 1402 who facilitates payment for the transaction from the account issued by the issuer (i) 1404 to account holder (a) 1408.

Transaction processing system 1400 has a plurality of acquirers (q) 1406. Each acquirer (q) 1406 may be assisted in processing one or more transactions by a corresponding agent acquirer (aq) 1406, where ‘q’ can be an integer from 1 to Q, where aq can be an integer from 1 to AQ, and where Q and AQ can be as large as a eight digit integer or larger. Each acquirer (q) 1406 may be assisted in processing one or more transactions by a corresponding agent acquirer (aq) 1406, where ‘q’ can be an integer from 1 to Q, where aq can be an integer from 1 to AQ, and where Q and AQ can be as large as a eight digit integer or larger.

The transaction handler (th) 1402 may process a plurality of transactions within the transaction processing system 1400. The transaction handler (th) 1402 can include one or a plurality or networks and switches (ns) 1402. Each network/switch (ns) 1402 can be a mainframe computer in a geographic location different than each other network/switch (ns) 1402, where ‘ns’ is an integer from one to NS, and where NS can be as large as a four digit integer or larger.

Dedicated communication systems 1420, 1422 (e.g., private communication network(s)) facilitate communication between the transaction handler (th) 1402 and each issuer (i) 1404 and each acquirer (a) 1406. A Network 1412, via e-mail, the World Wide Web, cellular telephony, and/or other optionally public and private communications systems, can facilitate communications 1422a-1422e among and between each issuer (i) 1404, each acquirer (a) 1406, each merchant (m) 1410, each account holder (a) 1408, and the transaction handler (th) 1402. Alternatively and optionally, one or more dedicated communication systems 1424, 1426, and 1428 can facilitate respective communications between each acquirer (a) 1406 and each merchant (m) 1410, each merchant (m) and each account holder (a) 1408, and each account holder (a) 1408 and each issuer (i) 1404, respectively.

The Network 1412 may represent any of a variety of suitable means for exchanging data, such as: an Internet, an intranet, an extranet, a wide area network (WAN), a local area network (LAN), a virtual private network, a satellite communications network, an Automatic Teller Machine (ATM) network, an interactive television network, or any combination of the forgoing. Network 1412 may contain either or both wired and wireless connections for the transmission of signals including electrical, magnetic, and a combination thereof. Examples of such connections are known in the art and include: radio frequency connections, optical connections, etc. To illustrate, the connection for the transmission of signals may be a telephone link, a Digital Subscriber Line, or cable link. Moreover, network 1412 may utilize any of a variety of communication protocols, such as Transmission Control Protocol/Internet Protocol (TCP/IP), for example. There may be multiple nodes within the network 1412, each of which may conduct some level of processing on the data transmitted within the transaction processing system 1400.

Users of the transaction processing system 1400 may interact with one another or receive data about one another within the transaction processing system 1400 using any of a variety of communication devices. The communication device may have a processing unit operatively connected to a display and memory such as Random Access Memory (“RAM”) and/or Read-Only Memory (“ROM”). The communication device may be combination of hardware and software that enables an input device such as a keyboard, a mouse, a stylus and touch screen, or the like.

For example, use of the transaction processing system 1400 by the account holder (a) 1408 may include the use of a portable consumer device (PCD). The PCD may be one of the communication devices, or may be used in conjunction with, or as part of, the communication device. The PCD may be in a form factor that can be: a card (e.g., bank card, payment card, financial card, credit card, charge card, debit card, gift card, transit pass, smart card, access card, a payroll card, security card, healthcare card, or telephone card), a tag, a wristwatch, wrist band, a key ring, a fob (e.g., SPEEDPASS® commercially available from ExxonMobil Corporation), a machine readable medium containing account information, a pager, a cellular telephone, a personal digital assistant, a digital audio player, a computer (e.g., laptop computer), a set-top box, a portable workstation, a minicomputer, or a combination thereof.

The PCD may have near field or far field communication capabilities (e.g., satellite communication or communication to cell sites of a cellular network) for telephony or data transfer such as communication with a global positioning system (GPS). The PCD may support a number of services such as SMS for text messaging and Multimedia Messaging Service (MMS) for transfer of photographs and videos, electronic mail (email) access.

The PCD may include a computer readable medium. The computer readable medium, such as a magnetic stripe or a memory of a chip or a chipset, may include a volatile, a non-volatile, a read only, or a programmable memory that stores data, such as an account identifier, a consumer identifier, and/or an expiration date. The computer readable medium may including executable instructions that, when executed by a computer, the computer will perform a method. For example, the computer readable memory may include information such as the account number or an account holder (a) 1408's name.

Examples of the PCD with memory and executable instructions include: a smart card, a personal digital assistant, a digital audio player, a cellular telephone, a personal computer, or a combination thereof. To illustrate, the PCD may be a financial card that can be used by a consumer to conduct a contactless transaction with a merchant, where the financial card includes a microprocessor, a programmable memory, and a transponder (e.g., transmitter or receiver). The financial card can have near field communication capabilities, such as by one or more radio frequency communications such as are used in a “Blue Tooth” communication wireless protocol for exchanging data over short distances from fixed and mobile devices, thereby creating personal area networks.

Merchant (m) 1410 may utilize at least one POI terminal (e.g., Point of Service or browser enabled consumer cellular telephone); that can communicate with the account user (au) 1408, the acquirer (a) 1406, the transaction handler (th) 1402, or the issuer (i) 1404. A Point of Interaction (POI) can be a physical or virtual communication vehicle that provides the opportunity, through any channel to engage with the consumer for the purposes of providing content, messaging or other communication, related directly or indirectly to the facilitation or execution of a transaction between the merchant (m) 1410 and the consumer. Examples of the POI include: a physical or virtual Point of Service (POS) terminal, the PCD of the consumer, a portable digital assistant, a cellular telephone, paper mail, e-mail, an Internet website rendered via a browser executing on computing device, or a combination of the forgoing. Thus, the POI terminal is in operative communication with the transaction processing system 1400.

The PCD may interface with the POI using a mechanism including any suitable electrical, magnetic, or optical interfacing system such as a contactless system using radio frequency, a magnetic field recognition system, or a contact system such as a magnetic stripe reader. To illustrate, the POI may have a magnetic stripe reader that makes contact with the magnetic stripe of a healthcare card (e.g., Flexible Savings Account card) of the consumer. As such, data encoded in the magnetic stripe on the healthcare card of consumer read and passed to the POI at merchant (m) 1410. These data can include an account identifier of a healthcare account. In another example, the POI may be the PCD of the consumer, such as the cellular telephone of the consumer, where the merchant (m) 1410, or an agent thereof, receives the account identifier of the consumer via a webpage of an interactive website rendered by a browser executing on a World Wide Web (Web) enabled PCD.

Typically, a transaction begins with account user (au) 1408 presenting the portable consumer device to the merchant (m) 1410 to initiate an exchange for resources (e.g., a good or service). The portable consumer device may be associated with an account (e.g., a credit account) of account holder (a) 1408 that was issued to the account holder (a) 1408 by issuer (i) 1404.

Merchant (m) 1410 may use the POI terminal to obtain account information, such as a number of the account of the account holder (a) 1408, from the portable consumer device. The portable consumer device may interface with the POI terminal using a mechanism including any suitable electrical, magnetic, or optical interfacing system such as a contactless system using radio frequency or magnetic field recognition system or contact system such as a magnetic stripe reader. The POI terminal sends a transaction authorization request to the issuer (i) 1404 of the account associated with the PCD. Alternatively, or in combination, the PCD may communicate with issuer (i) 1404, transaction handler (th) 1402, or acquirer (a) 1406.

Issuer (i) 1404 may authorize the transaction and forward same to the transaction handler (th) 1402. Transaction handler (th) 1402 may also clear the transaction. Authorization includes issuer (i) 1404, or transaction handler (th) 1402 on behalf of issuer (i) 1404, authorizing the transaction in connection with issuer (i) 1404's instructions such as through the use of business rules. The business rules could include instructions or guidelines from the transaction handler (th) 1402, the account holder (a) 1408, the merchant (m) 1410, the acquirer (a) 1406, the issuer (i) 1404, a related financial institution, or combinations thereof. The transaction handler (th) 1402 may, but need not, maintain a log or history of authorized transactions. Once approved, the merchant (m) 1410 may record the authorization, allowing the account user (au) 1408 to receive the good or service from merchant (m) or an agent thereof.

The merchant (m) 1410 may, at discrete periods, such as the end of the day, submit a list of authorized transactions to the acquirer (a) 1406 or other transaction related data for processing through the transaction processing system 1400. The transaction handler (th) 1402 may optionally compare the submitted authorized transaction list with its own log of authorized transactions. The transaction handler (th) 1402 may route authorization transaction amount requests from the corresponding the acquirer (a) 1406 to the corresponding issuer (i) 1404 involved in each transaction. Once the acquirer (a) 1406 receives the payment of the authorized transaction from the issuer (i) 1404, the acquirer (a) 1406 can forward the payment to the merchant (m) 1410 less any transaction costs, such as fees for the processing of the transaction. If the transaction involves a debit or pre-paid card, the acquirer (a) 1406 may choose not to wait for the issuer (i) 1404 to forward the payment prior to paying merchant (m) 1410.

There may be intermittent steps in the foregoing process, some of which may occur simultaneously. For example, the acquirer (a) 1406 can initiate the clearing and settling process, which can result in payment to the acquirer (a) 1406 for the amount of the transaction. The acquirer (a) 1406 may request from the transaction handler (th) 1402 that the transaction be cleared and settled. Clearing includes the exchange of financial information between the issuer (i) 1404 and the acquirer (a) 1406 and settlement includes the exchange of funds. The transaction handler (th) 1402 can provide services in connection with settlement of the transaction. The settlement of a transaction includes depositing an amount of the transaction settlement from a settlement house, such as a settlement bank, which transaction handler (th) 1402 typically chooses, into a clearinghouse bank, such as a clearing bank, that acquirer (a) 1406 typically chooses. The issuer (i) 1404 deposits the same from a clearinghouse bank, such as a clearing bank, which the issuer (i) 1404 typically chooses, into the settlement house. Thus, a typical transaction involves various entities to request, authorize, and fulfill processing the transaction.

The transaction processing system 1400 will preferably have network components suitable for scaling the number and data payload size of transactions that can be authorized, cleared and settled in both real time and batch processing. These include hardware, software, data elements, and storage network devices for the same. Examples of transaction processing system 1400 include those operated, at least in part, by: American Express Travel Related Services Company, Inc; MasterCard International, Inc.; Discover Financial Services, Inc.; First Data Corporation; Diners Club International, LTD; Visa Inc.; and agents of the foregoing.

Each of the network/switch (ns) 1402 can include one or more data centers for processing transactions, where each transaction can include up to 100 kilobytes of data or more. The data corresponding to the transaction can include information about the types and quantities of goods and services in the transaction, information about the account holder (a) 1408, the account user (au) 1408, the merchant (m) 1410, tax and incentive treatment(s) of the goods and services, coupons, rebates, rewards, loyalty, discounts, returns, exchanges, cash-back transactions, etc.

By way of example, network/switch (ns) 1402 can include one or more mainframe computers (e.g., one or more IBM mainframe computers) for one or more server farms (e.g., one or more Sun UNIX Super servers), where the mainframe computers and server farms can be in diverse geographic locations.

Each issuer (i) 1404 (or agent issuer (ai) 1404 thereof) and each acquirer (a) 1406 (or agent acquirer (aq) 1406 thereof) can use or more router/switch (e.g., Cisco™ routers/switches) to communicate with each network/switch (ns) 1402 via dedicated communication systems.

Transaction handler (th) 1402 can store information about transactions processed through transaction processing system 1400 in data warehouses such as may be incorporated as part of the plurality of networks/switches 1402. This information can be data mined. The data mining transaction research and modeling can be used for advertising, account holder and merchant loyalty incentives and rewards, fraud detection and prediction, and to develop tools to demonstrate savings and efficiencies made possible by use of the transaction processing system 1400 over paying and being paid by cash, or other traditional payment mechanisms.

The VisaNet® system is an example component of the transaction handler (th) 1402 in the transaction processing system 1400. Presently, the VisaNet® system is operated in part by Visa Inc. As of 2006, the VisaNet® system Inc. was processing around 300 million transaction daily, on over 1 billion accounts used in over 170 countries. Financial instructions numbering over 16,000 connected through the VisaNet® system to around 20 million merchants (m) 1410. In 2007, around 71 billion transactions for about 4 trillion U.S. dollars were cleared and settled through the VisaNet® system, some of which involved a communication length of around 24,000 miles in around two (2) seconds.

The steps, methods, processes, and devices described in connection with the implementations disclosed herein, are made with reference to the Figures, in which like numerals represent the same or similar elements. While described in terms of the best mode, it will be appreciated by those skilled in the art that the description is intended to cover alternatives, modifications, and equivalents as may be included within the spirit and scope of the invention as defined by the appended claims and their equivalents as supported by the following disclosure and drawings. Reference throughout this specification to “one implementation,” “an implementation,” or similar language means that a particular feature, structure, or characteristic described in connection with the implementation is included in at least one implementation of the present invention. Thus, appearances of the phrases “in one implementation,” “in an implementation,” and similar language throughout this specification may, but do not necessarily, all refer to the same implementation.

The described features, structures, or characteristics of the invention may be combined in any suitable manner in one or more implementations. In the following description, numerous specific details are recited to provide a thorough understanding of implementations of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow charts included are generally set forth as logical flow chart diagrams. As such, the depicted order and labeled steps are indicative of one implementation of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising a plurality of steps each being performed by a computing apparatus executing software, wherein the steps include:
receiving, from an address of an acquirer, acquirer encrypted data for a transaction upon an account for a purchase of an item from a merchant, wherein the acquirer encrypted data:
was formed by encrypting unencrypted data from the transaction using an acquirer zone key corresponding to the acquirer;
includes information sufficient to identify both:
an account holder to whom the account was issued by the issuer; and
the item of the purchase;
and
does not include information sufficient to identify the acquirer zone key;
decrypting the acquirer encrypted data for the transaction using the acquirer zone key to form the unencrypted data from the transaction;
encrypting the unencrypted data for the transaction using a vault key to form vault encrypted data for the transaction;
storing the vault encrypted data for the transaction;
receiving, from an address of the issuer, a transaction detail request corresponding to the transaction;
decrypting, using the vault key, in response to receiving the transaction detail request, the vault encrypted data for the transaction to form the unencrypted data from the transaction;
encrypting the unencrypted data for the transaction using an issuer zone key corresponding to the issuer to form issuer encrypted data for the transaction;
and
sending, for delivery to the address of the issuer, the issuer encrypted data for the transaction that:
includes information sufficient to identify both:
the account holder; and
the item of the purchase;
and
does not include information sufficient to identify the issuer zone key.

2. The method as defined in claim 1, wherein the steps further comprise:
receiving, from the address of the an acquirer, an authorization request for the transaction upon the account for the purchase of the item from the merchant, wherein:
the account was issued to the account holder by the issuer;
the authorization request includes an identifier for the account and a total currency amount for the purchase; and
the authorization request does not include information sufficient to identify both:
the account holder; and
the item of the purchase;
sending, for delivery to the address of the issuer, the authorization request;
receiving, from the address of the issuer, in response to the authorization request, an authorization response containing an authorization of the transaction upon the account for the purchase of the item; and
sending, for delivery to the address of the acquirer, the authorization response.

3. The method as defined in claim 1, wherein the steps further comprise storing the unencrypted data for the transaction in a data repository vault with the vault encrypted data for the transaction.

4. The method as defined in claim 1, wherein the account holder is a person.

5. The method as defined in claim 4, wherein the item is selected from the group consisting of:
a good provided to the person incident to a provision of a healthcare service to the person;
a service provided to the person incident to a provision of a healthcare service to the person;
a healthcare related good;
a healthcare related service; and
a combination of the foregoing.

6. The method as defined in claim 1, wherein each said step is performed by the computing apparatus at an address corresponding to a transaction handler.

7. The method as defined in claim 1, wherein the account holder is a participant in a transaction processing system in which a transaction handler processes each of a plurality of said transactions, each said transaction being characterized by one said merchant and one said account holder engaging in the transaction upon one said account that one said issuer issued to the one said account holder, wherein the one said merchant submits the transaction to one said acquirer for processing by the transaction handler who requests the one said issuer to obtain payment for the transaction from the account of the one said account holder, and wherein the one said issuer forwards the payment to the transaction handler who forwards the payment to the one said acquirer to pay the one said merchant for the transaction.

8. The method as defined in claim 1, wherein, after the step of sending the authorization response, the steps further comprise:
receiving, from the address of the acquirer, information for the transaction that:
is not sufficient to identify both:
the account holder; and
the item of the purchase;
is sufficient for clearing and settling the transaction purchase;
and
sending, for delivery to the address of the issuer, the information for the transaction.

9. A method comprising a plurality of steps each being performed by a computing apparatus executing software, wherein the steps include:
receiving, from an address of an acquirer, an authorization request for a transaction upon an account for a purchase of an item from a merchant, wherein:
the account was issued to an account holder by an issuer;
the authorization request includes an identifier for the account and a total currency amount for the purchase; and
the authorization request does not include information sufficient to identify both:
the account holder; and
the item of the purchase;
sending, to an address of the issuer, the authorization request;
receiving, from the address of the issuer, in response to the authorization request, an authorization response containing an authorization of the transaction upon the account for the purchase of the item;
sending, for delivery to the address of the acquirer, the authorization response;
receiving, from the address of the merchant, merchant data for the transaction that contain a merchant encrypted portion and a merchant unencrypted portion, wherein:
the merchant encrypted portion was formed by encrypting unencrypted data for the transaction using a merchant key corresponding to the merchant, wherein the merchant encrypted data includes information sufficient to identify both:
the account holder; and
the item of the purchase; and
does not include information sufficient to identify the merchant key;
the merchant unencrypted portion contains data for the transaction;
sending, for delivery to the address of the issuer, the merchant unencrypted portion that:
includes information sufficient for clearing and settling the transaction; and
does not include information sufficient to identify both:
the account holder; and
the item of the purchase;
decrypting the merchant encrypted data for the transaction using the merchant key to form the unencrypted data from the transaction;
encrypting the unencrypted data for the transaction using a vault key to form vault encrypted data for the transaction;
storing the vault encrypted data for the transaction in a data repository vault;
receiving, from the address of the issuer, a transaction detail request corresponding to the transaction;
decrypting, using the vault key, in response to receiving the transaction detail request, the vault encrypted data for the transaction to form the unencrypted data from the transaction;
encrypting the unencrypted data for the transaction, using an issuer zone key corresponding to the issuer, to form issuer encrypted data for the transaction;
and
sending, for delivery to the address of the issuer, the issuer encrypted data for the transaction that:
includes information sufficient to identify both:
the account holder; and
the item of the purchase;
and
does not include information sufficient to identify the issuer zone key.

10. The method as defined in claim 9, wherein the steps further comprise storing the unencrypted data in the data repository vault.

11. The method as defined in claim 9, wherein the account holder is a person.

12. The method as defined in claim 11, wherein the item is selected from the group consisting of:
a good provided to the person incident to a provision of a healthcare service to the person;
a service provided to the person incident to a provision of a healthcare service to the person;
a healthcare related good;
a healthcare related service; and
a combination of the foregoing.

13. The method as defined in claim 9, wherein the steps further comprise storing the unencrypted data for the transaction.

14. The method as defined in claim 9, wherein each said step is performed by the computing apparatus at an address corresponding to a transaction handler.

15. The method as defined in claim 9, wherein the account holder is a participant in a transaction processing system in which a transaction handler processes each of a plurality of said transactions, each said transaction being characterized by one said merchant and one said account holder engaging in the transaction upon one said account that one said issuer issued to the one said account holder, wherein the one said merchant submits the transaction to one said acquirer for processing by the transaction handler who requests the one said issuer to obtain payment for the transaction from the account of the one said account holder, and wherein the one said issuer forwards the payment to the transaction handler who forwards the payment to the one said acquirer to pay the one said merchant for the transaction.

16. A method comprising a plurality of steps each being performed by a computing apparatus executing software, wherein the steps include:
receiving, from an address of an acquirer, an authorization request for a transaction upon an account for a purchase of an item from a merchant, wherein:
the account was issued to an account holder by an issuer;
the account holder is a participant in a transaction processing system in which a transaction handler processes each of a plurality of said transactions, each said transaction being characterized by one said merchant and one said account holder engaging in the transaction upon one said account that one said issuer issued to one said account holder, wherein the one said merchant submits the transaction to one said acquirer for processing by the transaction handler who requests the one said issuer to obtain payment for the transaction from the account of the one said account holder, and wherein the one said issuer forwards the payment to the transaction handler who forwards the payment to the one said acquirer to pay the one said merchant for the transaction;
the authorization request includes an identifier for the account and a total currency amount for the purchase; and
the authorization request does not include information sufficient to identify both:
the account holder; and
the item of the purchase;
sending, to an address of the issuer, the authorization request;
receiving, from the address of the issuer, in response to the authorization request, an authorization response containing an authorization of the transaction upon the account for the purchase of the item;
sending, for delivery to the address of the acquirer, the authorization response;
receiving, from the address of the acquirer, information for the transaction that:
is not sufficient to identify both:
the account holder; and
the item of the purchase;
is sufficient for clearing and settling the transaction purchase;
sending, for delivery to the address of the issuer, the information for the transaction;
receiving, from the address of the acquirer, acquirer encrypted data for the transaction that:
was formed by encrypting unencrypted data from the transaction using an acquirer zone key corresponding to the acquirer;
includes information sufficient to identify both:
the account holder; and
the item of the purchase;
and
does not include information sufficient to identify the acquirer zone key;
decrypting the acquirer encrypted data for the transaction using the acquirer zone key to form the unencrypted data from the transaction;
encrypting the unencrypted data for the transaction using a vault key to form vault encrypted data for the transaction;
storing the vault encrypted data for the transaction;
receiving, from an address of the issuer, a transaction detail request corresponding to the transaction;
decrypting, using the vault key, in response to receiving the transaction detail request, the vault encrypted data for the transaction to form the unencrypted data from the transaction;
encrypting the unencrypted data for the transaction using an issuer zone key corresponding to the issuer to form issuer encrypted data for the transaction;
and
sending, for delivery to the address of the issuer, the issuer encrypted data for the transaction that:
includes information sufficient to identify both:
the account holder; and
the item of the purchase;
and
does not include information sufficient to identify the issuer zone key.

17. The method as defined in claim 16, wherein the steps further comprise storing the unencrypted data in a data repository vault with the vault encrypted data for the transaction.

18. The method as defined in claim 16, wherein the account holder is a person.

19. The method as defined in claim 16, wherein the item is selected from the group consisting of:
a good provided to the person incident to a provision of a healthcare service to the person;
a service provided to the person incident to a provision of a healthcare service to the person;
a healthcare related good;
a healthcare related service; and
a combination of the foregoing.

20. The method as defined in claim 16, wherein each said step is performed by the computing apparatus at an address corresponding to a transaction handler.
